(19) United States
(12) Patent Application Publication
(10) Pub. No.: US 2005/0190053 A1
(43) Pub. Date: Sep. 1, 2005

(54) Managing an occupant of a structure during an emergency event

(76) Inventor: Diegane Dione, Brooklyn, NY (US)

Correspondence Address: HOFFMAN WARNICK & D'ALESSANDRO, LLC, 75 STATE STREET, 14TH FL, ALBANY, NY, 12207, US

(21) Appl. No.: 11/113,774

(22) Filed: Apr. 25, 2005

Related U.S. Application Data
(63) Continuation-in-part of application No. 10/784,729, filed on Feb. 23, 2004.
(63) Continuation-in-part of application No. 10/764,258, filed on Jan. 23, 2004.
(60) Provisional application No. 60/565,480, filed on Apr. 26, 2004.
(60) Provisional application No. 60/587,582, filed on Jul. 13, 2004.
(60) Provisional application No. 60/449,373, filed on Feb. 24, 2003.
(60) Provisional application No. 60/497,646, filed on Aug. 25, 2003.
(60) Provisional application No. 60/541,652, filed on Feb. 4, 2004.
(60) Provisional application No. 60/442,811, filed on Jan. 24, 2003.
(60) Provisional application No. 60/449,373, filed on Feb. 24, 2003.
(60) Provisional application No. 60/497,646, filed on Aug. 25, 2003.

(51) Int. Cl. G08B 23/00

(52) U.S. Cl. 340/500

(57) ABSTRACT

An occupant management method, system, and program product that associate occupant information with information about a physical area. For example, the invention can generate a hierarchical representation of a physical area such as a building or the like. The hierarchical representation is used to manage occupants of the physical area. For example, contact information for occupants can be maintained and associated with a physical location, and/or directions can be provided from a starting point to a designated destination point. The hierarchical representation can be used to facilitate two-way communication between an occupant and an emergency responder during an emergency event. Further, a response plan can be defined for an emergency event and implemented when the emergency event is identified.

### REFERENCE TO RELATED APPLICATIONS

The current application is a continuation-in-part of U.S. application Ser. No. 10/784,729, filed on Feb. 23, 2004, and claims the benefit of U.S. Provisional Application Nos. 60/565,480, filed on Apr. 26, 2004, and 60/587,582, filed on Jul. 13, 2004, each of which is incorporated herein by reference; U.S. application Ser. No. 10/784,729 is a continuation-in-part of U.S. application Ser. No. 10/764,258, filed on Jan. 23, 2004, and claims the benefit of U.S. Provisional Application Nos. 60/449,373, filed on Feb. 24, 2003, 60/497,646, filed on Aug. 25, 2003, and 60/541,652, filed on Feb. 4, 2004, each of which is hereby incorporated herein by reference; U.S. application Ser. No. 10/764,258 claims the benefit of U.S. Provisional Application Nos. 60/442,811, filed on Jan. 24, 2003, 60/449,373, filed on Feb. 24, 2003, and 60/497,646, filed on Aug. 25, 2003.

### BACKGROUND OF THE INVENTION

1. Technical Field

The invention relates generally to managing occupants of a physical area, such as one or more buildings, and more specifically, to a method, system, and program product that associate occupant information to information regarding a physical area. The physical area information can be used to access the associated occupant information and provide information to occupants.

The invention further relates generally to responding to an emergency event that affects the physical area, and more specifically, to a method, system, and program product that use a predefined response plan to communicate with occupants and/or responders of the physical area during an emergency event.

Still further, the invention relates generally to managing an occupant of a structure during an emergency event and more specifically to obtaining location and/or evacuation information from the occupant during the emergency event.

2. Related Art

For most companies, employees continue to be assigned a desk and/or office within one or more buildings. During the work day, most employees are primarily located at their assigned desk/office. While at work, an employee typically uses a desktop computer, telephone, and the like in the office to communicate with co-workers and perform his/her work. Increasingly, companies are providing employees with personal communication devices such as personal digital assistants (PDAs), pagers, mobile telephones, and the like. These devices enable an employee to communicate with others in the company, check e-mail, check voice mail, etc., when the employee is away from his/her office. Further, employees may purchase one or more personal communication devices that family members and friends typically use to contact the employee. As a result, while at work, there are often several forms of communication that can be used to contact a particular employee.

For a new employee, time may be unnecessarily spent determining the location of various rooms such as a bathroom, conference room, etc. Additionally, an employee may need to determine an office location of a co-worker, or contact information for the co-worker such as an extension. Further, in public buildings such as an airport, a mall, or the like, a user may desire directions to a particular gate, a desired store, etc. While maps are typically provided periodically throughout these buildings, occupants frequently find that they are not convenient or easy to read.

As a result, a need exists for a solution that provides information about occupants of a physical area to another occupant of the physical area in an efficient manner that can be based on the location of the occupant. A further need exists for providing custom directions to an occupant of a building or other structure based on the occupant's current location and a specified destination location. To this extent, a need exists for a solution that generates and/or uses a hierarchical representation of a physical area to provide directions and/or occupant information to an occupant using any type of communication device, and in particular, a wireless communication device such as a PDA or a mobile telephone.

Further, emergency responders such as police, fire, and emergency medical technicians (EMTs), and the like are increasingly being equipped with personal communication devices that allow the responders to maintain contact with each other while responding to an emergency situation. This communication equipment has enabled the responders to cooperate better and respond to the emergency in a more efficient manner. However, to date, little or no communication occurs between the emergency responders and occupants of a building in which the emergency (e.g., a fire) is occurring. As a result, responders must spend a great deal of time and effort in determining whether any occupants remain in a building, the likely location of the occupants, and whether they are safe or in danger. All too often, responders enter an unsafe structure under a mistaken belief that an occupant remains inside, thereby exposing the responder to an unnecessary risk.

As a result, a further need exists for a solution that enables responders and occupants to communicate during an emergency event. In particular, a need exists for a method, system, and program product that obtains information for occupants of a physical area such as a building, and assigns the information to a location in the physical area where the occupant is or is most likely to be located. In this manner, emergency responders can use the information to contact and/or attempt to contact the occupant as well as determine a region within the physical area in which to search for the occupant.

### SUMMARY OF THE INVENTION

The invention provides a solution for managing occupants of a physical area. Specifically, under the present invention, occupant information is associated with information about the physical area, and is used to obtain information about and provide information to occupants of the physical area. In one embodiment, a hierarchical representation of the physical area is obtained, and occupant information is associated with the hierarchical representation. In particular, a node that includes occupant information is associated with a node that represents a portion of the physical area in which the occupant is or is likely to be located. The hierarchical representation can be used in various applications. For example, each area node can include directions to exit points for a corresponding parent area. The directions can be used to construct directions for an occupant from a start location to a destination location. Further, contact information for locations and/or occupants can be included to enable various options for contacting an occupant to be readily obtained. In one embodiment, the contact information is used by emergency responders to obtain a status for one or more occupants, and/or allow an emergency responder to communicate with an occupant. The hierarchical representation can be updated dynamically, e.g., based on detected movement of occupants, or can be more static, e.g., based on office locations of occupants. In either case, the invention provides an improved solution for managing occupants of a physical area.

The invention can further comprise a solution for responding to an emergency event that affects the physical area. Specifically, under the present invention, a response plan can be planned for one or more types of emergency events (e.g., personal injury, fire, earthquake, etc.). The response plan can include one or more response operations that are each associated with a responder, occupant, and/or area for the physical area. Each response operation can be implemented when the emergency event is identified to improve the response to the emergency event.

A first aspect of the invention provides a method of managing occupants of a building during an emergency event, the method comprising: obtaining building information for a plurality of areas of the building; associating occupant information for an occupant located at one of the plurality of areas of the building with the corresponding building information; contacting the occupant using the occupant information during the emergency event; and obtaining a status of the occupant.

A second aspect of the invention provides a method of managing occupants of a physical area, the method comprising: obtaining a plan for the physical area; generating a hierarchical representation of the physical area based on the plan, wherein the hierarchical representation includes a plurality of area nodes; obtaining occupant information for an occupant of the physical area; and associating the occupant information with an area node in the hierarchical representation.

A third aspect of the invention provides a system for managing occupants of a physical area, the system comprising: means for obtaining a plan for the physical area; means for generating a hierarchical representation of the physical area based on the plan; means for obtaining occupant information for an occupant of the physical area; and means for associating the occupant information with an area node in the hierarchical representation.

A fourth aspect of the invention provides a computer program product comprising a computer useable medium having computer readable program code embodied therein for managing occupants of a physical area, the program product comprising: program code configured to obtain a plan for the physical area; program code configured to generate a hierarchical representation of the physical area based on the plan; program code configured to obtain occupant information for an occupant of the physical area; and program code configured to associate the occupant information with an area node in the hierarchical representation.

A fifth aspect of the invention provides a method of managing occupants of a physical area during an emergency event, the method comprising: identifying the emergency event; and activating a response plan based on the identified emergency event, wherein the activating step includes initiating at least one response operation for the response plan; selecting an occupant of the physical area based on a location of the emergency event; and providing instructions to the occupant based on the emergency event.

A sixth aspect of the invention provides a system for evacuating an occupant of a physical area during an emergency event, the system comprising: means for identifying the emergency event; means for automatically informing the occupant of the emergency event; means for obtaining a location of the occupant; means for obtaining an evacuation status of the occupant; and means for providing instructions to the occupant based on at least one of the emergency event, the location, and the evacuation status.

A seventh aspect of the invention provides a computer program product comprising a computer useable medium having computer readable program code embodied therein for responding to an emergency event, the program product comprising: program code configured to identify the emergency event; program code configured to activate a response plan based on the identified emergency event; and program code configured to perform a response operation based on the response plan, wherein the response operation includes: program code configured to obtain a status and a location of an occupant; and program code configured to provide instructions to the occupant.

An eighth aspect of the invention provides a method of managing an occupant of a structure during an emergency event, the method comprising: obtaining an emergency response management system for the structure prior to the emergency event; establishing communications between the emergency response management system and a personal wireless communication device of the occupant; obtaining location information for the occupant on the emergency response management system, wherein the location information is based on at least one of an occupant profile, contact information used in establishing communications, or a communication received from the personal wireless communication device via at least one of an Internet message, a text message, a selection of at least one menu option, or a verbal statement; and providing the location information from the emergency response management system for use by a responder.

A ninth aspect of the invention provides a system for managing an occupant of a structure during an emergency event, the system comprising: an emergency response management system; means for establishing communications between the emergency response management system and a personal wireless communication device of the occupant; means for obtaining location information for the occupant on the emergency response management system, wherein the location information is based on at least one of an occupant profile, contact information used in establishing communications, or a communication received from the personal wireless communication device via at least one of an Internet message, a text message, a selection of at least one menu option, or a verbal statement; and means for providing the location information from the emergency response management system for use by a responder.

A tenth aspect of the invention provides a computer-readable medium comprising computer program code, which when executed, enables a computer infrastructure to manage an occupant of a structure during an emergency event, the computer program code comprising: means for obtaining an emergency response management system for the structure prior to the emergency event; means for establishing communications between the emergency response management system and a personal wireless communication device of the occupant; means for obtaining location information for the occupant on the emergency response management system, wherein the location information is based on at least one of an occupant profile, contact information used in establishing communications, or a communication received from the personal wireless communication device via at least one of an Internet message, a text message, a selection of at least one menu option, or a verbal statement; and means for providing the location information from the emergency response management system for use by a responder.

An eleventh aspect of the invention provides a business method for managing an occupant of a physical area.

A twelfth aspect of the invention provides a method of generating a system for managing an occupant of a physical area.

A thirteenth aspect of the invention provides a method and system for developing an architectural design for a structure.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative hierarchical representation of a building;

FIG. 2 shows illustrative method steps for generating a hierarchical representation of a building;

FIG. 3 shows an illustrative system for managing occupants of a physical area;

FIG. 4 shows illustrative method steps for obtaining a status of an occupant during an emergency event;

FIG. 5 shows alternative method steps for generating a hierarchical representation of a building;

FIG. 6 shows an illustrative hierarchical representation of a city;

FIG. 7 shows an illustrative data relationship diagram for a response plan;

FIG. 8 shows an illustrative method of responding to a chemical spill;

FIGS. 9A-I show illustrative occupant interfaces according to one embodiment of the invention;

FIGS. 10A-C show illustrative responder interfaces according to one embodiment of the invention;

FIG. 11 shows a second illustrative system for managing an occupant of a structure;

FIG. 12 shows an illustrative floor of a structure;

FIG. 13 shows illustrative method steps for generating an evacuation route;

FIG. 14 shows illustrative method steps for generating a direction template;

FIG. 15 shows illustrative method steps for determining a next available opening; and

FIG. 16 shows illustrative method steps for determining a destination point.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

For convenience purposes only, the following outline is used in the description:
I. HIERARCHICAL REPRESENTATION
II. OVERVIEW OF AN ILLUSTRATIVE SYSTEM
III. APPLICATIONS
   A. DIRECTIONS AND CONTACT INFORMATION
   B. EMERGENCY RESPONSE
IV. PREDEFINED RESPONSE PLAN
V. SAMPLE USER INTERFACES
VI. OVERVIEW OF SECOND ILLUSTRATIVE SYSTEM
VII. ILLUSTRATIVE FUNCTIONS
   A. ADMINISTRATION
   B. REGISTRATION
   C. EVACUATION
   D. FIRE CODE COMPLIANCE
   E. COMMUNICATION/ASSISTANCE
VIII. ALTERNATIVES
   I. Hierarchical Representation

As indicated above, the invention provides a solution for managing occupants of a physical area. Specifically, under the present invention, occupant information is associated with information about the physical area, and is used to obtain information about and provide information to occupants of the physical area. In one embodiment, a hierarchical representation of the physical area is obtained, and occupant information is associated with the hierarchical representation. In particular, a node that includes occupant information is associated with a node that represents a portion of the physical area in which the occupant is or is likely to be located. The hierarchical representation can be used in various applications. For example, each area node can include directions to exit points for a corresponding parent area. The directions can be used to construct directions for an occupant from a start location to a destination location within the physical area. Further, contact information for locations and/or occupants can be included to enable various options for contacting an occupant to be readily obtained. In one embodiment, the contact information is used by emergency responders to obtain a status for one or more occupants, and/or allow an emergency responder to communicate with an occupant. The hierarchical representation can be updated dynamically, e.g., based on detected movement of occupants, or can be more static, e.g., based on office locations of occupants. In either case, the invention provides an improved solution for managing occupants of a physical area.

The following discussion of various aspects of the invention uses one application in which the physical area comprises a building, and more particularly an office building or publicly accessible building. However, it is understood that the teachings of the invention are not limited to this type of application. In particular, the teachings allow the system to be readily scaled into larger applications or smaller applications. To this extent, while the following discussion focuses on a building, it is understood that the teachings apply to any physical area, including other structures (e.g., a stadium or an airport), multiple buildings (e.g., a business park or a city block), a portion of a building, an apartment building, a house, a town or city, etc. Further, while the discussion uses a building plan as an illustrative plan for a physical area, it is understood that this could comprise any type of plan, including a map, a blueprint, etc. Still further, as will be made clear by the discussion below, “occupant” is used to refer to an individual that is, or may be, present within the physical area.

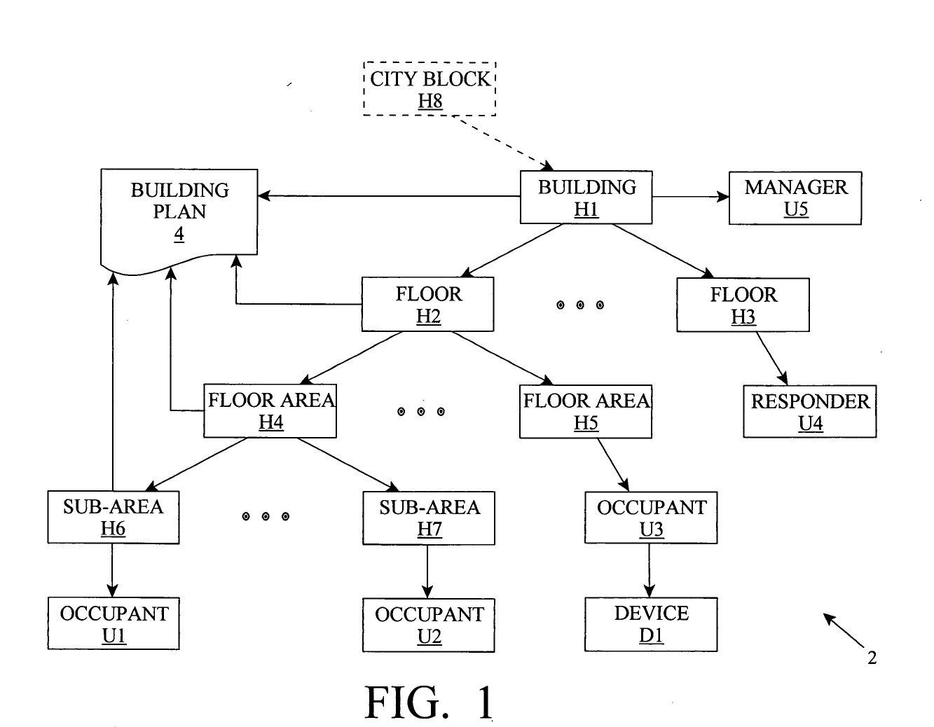

As noted previously, one aspect of the invention provides for the generation of information about a physical area such as a building. In one embodiment, a hierarchical representation of the building is generated. In particular, the building can be subdivided in a hierarchical manner into increasingly smaller units of physical area. Each unit of physical area can be represented by an area node in the hierarchical representation, and the area node can include information about the physical area. Turning to the drawings, FIG. 1 shows an illustrative hierarchical representation 2 of a building. Hierarchical representation 2 is shown including a building node H1 for the building as a top level node. However, as discussed above, the physical area could be larger or smaller than a building. To this extent, hierarchical representation 2 could comprise a portion of a larger hierarchical representation. For example, building node H1 could be the child node of a city block node H8. In this manner, hierarchical representation 2 provides an efficient manner for increasing and/or decreasing the scale of the physical area. However, it is understood that hierarchical representation 2 is only illustrative of the various types of data structures that could be used to efficiently store and access information about a physical area. To this extent, the invention is not limited to use of hierarchical representation 2.

Continuing with hierarchical representation 2, an area node such as building node H1 can have one or more child area nodes that each correspond to smaller areas included within the larger area. To this extent, for one or more floors of a building, a floor node H2-H3 can be added as a child of building node H1. Similarly, each floor node H2-H3, can have one or more floor area nodes H4-H5 as a child node that each correspond to unique physical areas of the corresponding floor. A floor area could comprise, for example, one or more rooms that are formed by a fixed wall. Consequently, a hall, a reception area, an office, a bathroom, etc., each could have a floor area node H4-H5 in hierarchical representation 2. When the building comprises an office building, floor area nodes H4-H5 could each represent an area of the corresponding floor that is occupied by a different company. In any event, a floor area may be further sub-divided into rooms, cubicles formed by temporary walls, areas of a room, or the like. As a result, one or more floor area nodes H4-H5 could also have one or more sub-area nodes H6-H7 as a child. It is understood that hierarchical representation 2 is only illustrative. In particular, alternative hierarchical representations may include additional or fewer levels and nodes that subdivide the building using any solution.

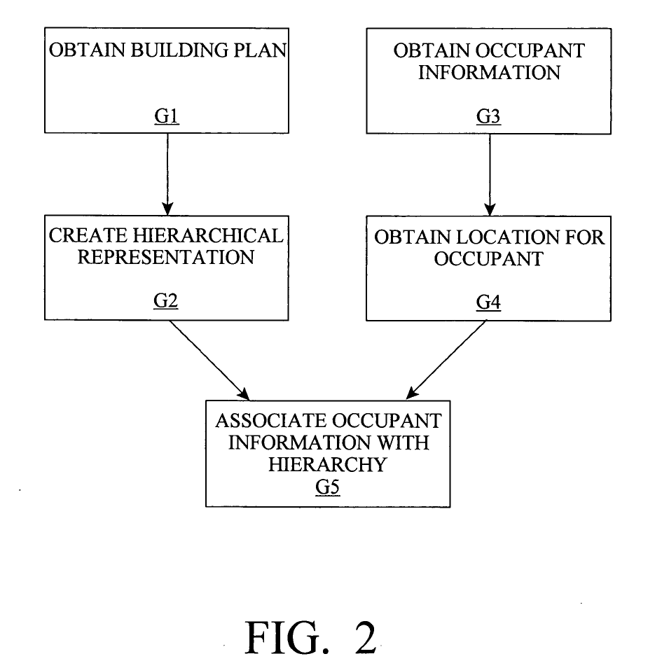

FIG. 2 shows an illustrative method for generating the hierarchical representation 2 shown in FIG. 1. In step G1, a building plan 4 (FIG. 1) is obtained. Building plan 4 could comprise a physical copy such as a printed plan, blueprint, etc., or comprise an electronic copy stored on a computer useable medium such as one or more computer-aided design (CAD) drawings, graphic files, etc. In either case, the obtaining step could comprise generating building plan 4, accessing an existing building plan 4, and/or converting building plan 4 from one form (physical copy) into a more suitable form (electronic copy). In any event, building plan 4 will include information on each floor of the building, such as its shape and dimensions, the location of walls, exits, etc.

In step G2, hierarchical representation 2 (FIG. 1) of the building is generated using building plan 4 (FIG. 1). In particular, each unique floor in the building can be identified in building plan 4, and a corresponding floor node H2-H3 (FIG. 1) can be created and added to hierarchical representation 2. Similarly, areas and/or rooms on a floor, cubicles in a room, and the like can be identified in building plan 4 and added to hierarchical representation 2 in the appropriate locations. Floors, areas, sub-areas and the like can be identified manually, automatically, or some combination thereof. For example, a user could refer to a physical building plan 4, and generate hierarchical representation 2. Alternatively, a user could outline an area in an electronic building plan 4 and define a corresponding floor area node H4-H5 or sub-area node H6-H7. Further, a computer program product can be used to identify walls, exit points, etc. in an electronic building plan 4 and automatically generate some or all of hierarchical representation 2.

As shown in FIG. 1, when building plan 4 is in an electronic format, one or more area nodes H1-H7 can be associated with its corresponding portion of building plan 4. For example, each floor node H2-H3 could be linked to the portion of building plan 4 that includes the entire floor, while floor area node H5 may be linked to a particular area of the floor corresponding to floor node H2. By linking one or more area nodes H1-H7 to building plan 4, the portion of building plan 4 that corresponds to a selected area node H1-H7 can be readily displayed to a user in a zoomed in and/or highlighted fashion. Further, a user could view building plan 4 and be provided a corresponding area node H1-H7 after selecting a location in building plan 4.

Hierarchical representation 2 is also shown including user nodes U1-U5 that are associated with one or more area nodes H1-H7. Each user node U1-U5 can include user information for a corresponding user. In particular, user nodes U1-U3 can each comprise occupant information U1-U3 for a building occupant. Returning to FIG. 2, in step G3, occupant information U1-U3 for one or more building occupants can be obtained. Occupant information U1-U3 can be manually entered, automatically retrieved from an existing database or the like, or some combination thereof. For example, occupant information U1-U3 can be provided by the corresponding occupant of the building. Alternatively, occupant information U1-U3 can be imported from a human resources database or the like. Still further, occupant information U1-U3 can be dynamically obtained by communicating with a wireless device or the like that is unique to a particular occupant.

In any event, returning to FIG. 2, in step G4 a location is obtained for each occupant of the building. In one embodiment, the location can be based on the most likely location of an occupant within the building, for example, the location of an occupant's office. Alternatively, the location can be obtained and updated dynamically by communicating with, for example, a wireless device carried by the occupant as he/she moves throughout the building. Still further, a combination of the two could be used. In the latter case, a first location for an occupant can be based on his/her office and, when the occupant is not in the office, a second location can be based on the current location of the occupant. In this case, occupant information U1-U3 (FIG. 1) could include a status that indicates whether or not the occupant is present at the location. It is understood that additional status information can also be included in occupant information U1-U3. For example, any health problems that the occupant may have could be included as status information in occupant information U1-U3.

Regardless, instep G5, occupant information U1-U3 is associated with hierarchical representation 2 (FIG. 1). In particular, as shown in FIG. 1, occupant information U1-U3 can be associated with an area node H1-H7 that corresponds to the location that was obtained for the occupant. For example, occupant information U1 can be associated with sub-area node H6 that corresponds to the location of the occupant's desk, and occupant information U2 can be associated with a sub-area node H7 that corresponds to a current location of the occupant.

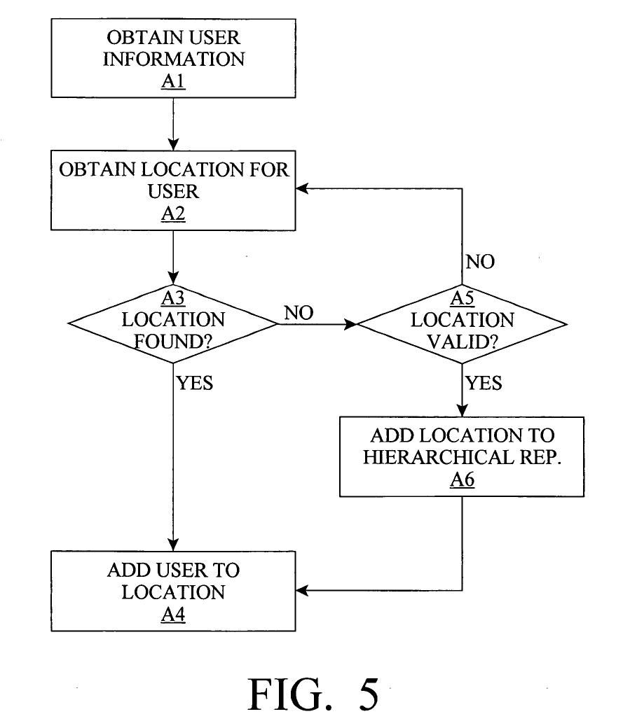

Hierarchical representation 2 can also be generated dynamically as each user creates his/her user node U1-U5, and associates it with a physical location. For example, building plan 4 may not be available and/or registration may be performed in an unorganized manner by multiple users. In any event, FIG. 5 shows an alternative method for generating hierarchical representation 2 (FIG. 1). In step A1, a user can enter his/her user information U1-U5 (FIG. 1) by using, for example, his/her personal device. In step A2, the user can enter location information for his/her corresponding location, e.g., his/her office. In one embodiment, the user answers a series of questions and/or makes a series of selections to identify his/her location. Each successive question/selection can further limit the physical area of the user's location. For example, the user can be prompted to identify the building (e.g., street address), a floor, a room number, a cubicle number, etc.

Continuing with step A3, once entered, the location information can be compared to existing area nodes H1-H7 in hierarchical representation 2 (FIG. 1). In step A4, user information U1-U5 (FIG. 1) is associated with the corresponding area node H1-H7 (FIG. 1) when the entered location information matches the location information for an area node H1-H7 in hierarchical representation 2. When the location information does not match any area node H1-H7, then in step A5, the user is asked to confirm the location information. If the user indicates that the location information is not valid, then processing can return to step A2 to obtain corrected location information. However, if the user indicates that the location information is correct, then in step A6, a new area node H1-H7 can be added to hierarchical representation 2. In particular, the location information can be analyzed to determine an appropriate location for the new area node H1-H7. For example, if area nodes H1-H7 exist for the specified building and floor, but not for the specified room number, then the new area node H1-H7 can be placed in hierarchical representation 2 beneath the existing floor node H2-H3. In step A4, user information U1-U5 can be associated with the new area node H1-H7.

Returning to FIG. 1, various interfaces can be provided to the user in an effort to ensure the integrity of the entered location information. For example, when designating a location, the user can be presented with a list of locations currently having area nodes H1-H7 within hierarchical representation 2 for each selection. The user can select the appropriate location from the list or choose to add a new location. In the latter case, the user can confirm that the entered location information is correct before a corresponding area node H1-H7 is added to hierarchical representation 2. For example, an occupant could initially enter his/her occupant information U3 and corresponding device information D1. Subsequently, the occupant can be prompted identify his/her office location. To this extent, the occupant could select an entry that corresponds to building node H1, and a floor that corresponds to floor node H2. However, hierarchical representation 2 may not already include a floor area node (e.g., floor area node H5) that corresponds to the user's office number for selection. In this case, the user can request to enter a new office number. A new floor area node H5 can be added to hierarchical representation 2 that corresponds to the new office number, and occupant information U3 can be associated with it. When a new area node H1-H7 is added to hierarchical representation 2, the user or a designated user can be requested to manually enter in additional location information such as directions to one or more locations(s) (e.g., stairs, elevator, bathroom, etc.), communication information for the area node H1-H7 (e.g., telephone extension, intercom, network address, etc.), and the like.

FIG. 1 also shows user nodes U4-U5 associated with hierarchical representation 2 that include user information for other users. User information U4-U5 can be associated with hierarchical representation 2 in a manner similar to occupant information U1-U3. However, user information U4-U5 can be associated with an area node H1-H7 based on a situation that may occur within the corresponding area. To this extent, user information U4-U5 may correspond to occupants or non-occupants of the building. For example, as described further below with reference to an illustrative application, user information U4 can correspond to an emergency responder, and be associated with floor node H3. In this case, user information U4 can be used when an emergency event occurs on the floor corresponding to floor node H3. Similarly, user information U5 can correspond to a building manager and be used when a problem occurs with the building (e.g., a water leak or heating problem).

User information for each user can be stored in a user node U1-U5, or can be stored in a user node U1-U5 having one or more child nodes. In the latter case, each user node U1-U5 can include information personal to the user (e.g., his/her name), and each child node can include information about an item associated with the corresponding user. For example, user node U3 is shown having a device node D1 as a child node. Device node D1 can include device information that corresponds to a personal device that can be used to contact the corresponding user. Other information such as electronic mailing address(es), family member(s), etc., could be similarly stored in user node U1-U5 and/or one or more child nodes.

It is understood that while hierarchical representation 2 only shows user information U1-U5 for a single user associated with an area node H1-H7, user information U1-U5 for multiple users could be associated with an area node H1-H7. For example, floor area node H5 could correspond to a conference room, and user information U1-U5 could be associated with floor area node H5 for each occupant taking part in a meeting in the conference room. Further, a user could have his/her user information U1-U5 associated with multiple area nodes H1-H7 in hierarchical representation 2 based on his/her location and/or based on one or more situations in which the user is contacted. For example, user information U4 could correspond to an occupant of floor H3. Similarly, in addition to user information U5, the building manager could have his/her information associated with an area node H1-H7 that corresponds to his/her office location. Information stored in area nodes H1-H7, user nodes U1-U5, and/or device node D1 can vary based on the applications in which hierarchical representation 2 is used. Examples of information that can be included will be discussed further below with reference to illustrative applications.

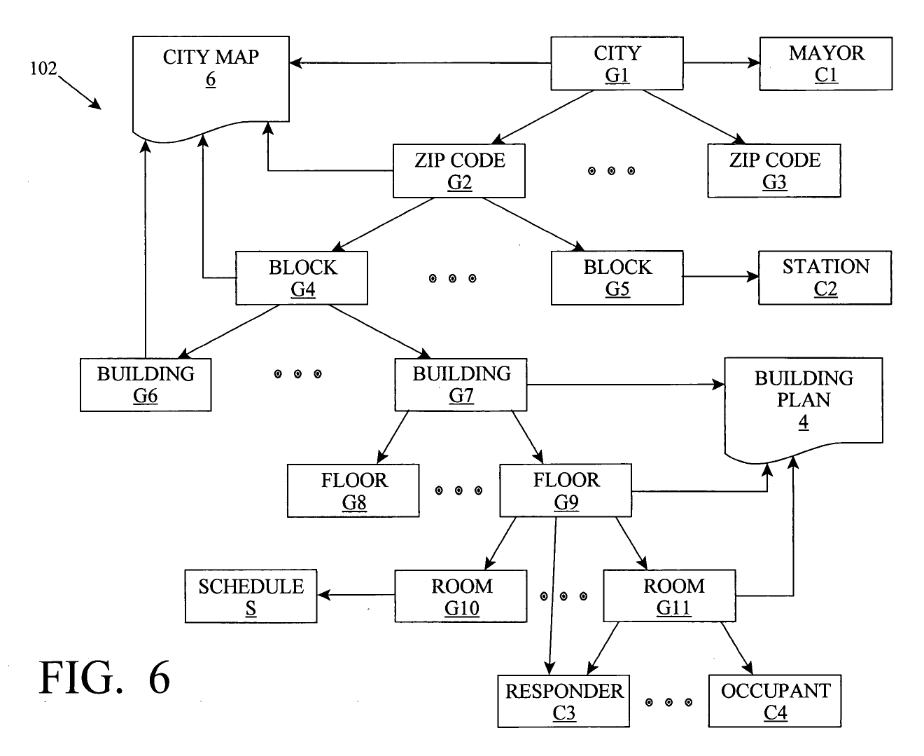

Numerous alternative hierarchical representations are possible. For example, FIG. 6 shows a hierarchical representation 102 that represents a geographic area such as a city. As shown, hierarchical representation 102 could comprise several levels of area nodes G1-G11 comprising a city node G1, zip code nodes G2-G3, block nodes G4-G5, and building nodes G6-G7. In this case, area information can be obtained from a city map 6 or the like, and area nodes G1-G7 can be linked to city map 6. User information C1-C4 associated with area nodes G1-G7 could comprise mayor information C1 that is associated with city node G1, and responder information C2 that is associated with a block node G5. Mayor information C1 and/or station information C2 can comprise general contact information for an office (e.g., mayor's office, fire station) that is associated with the corresponding geographic area. To this extent, an occupant and/or other user can comprise a corporation or the like, rather than a particular individual. Further, the occupant/user could comprise a hierarchical representation of the corporation or other entity.

Further, floor node G9 is shown associated with responder C3, which is also associated with room node G11. Responder C3 could comprise an occupant of the corresponding floor (e.g., in the room represented by room node G11) that is a designated foreman or the like. In this case, responder C3 could be responsible for ensuring that occupants of floor G9 evacuate safely when an emergency event occurs. Room node G10 is also shown having an associated schedule S. Schedule S could comprise, for example, a schedule of events (e.g., meetings, courses) that are scheduled to occur in room G10. Based on schedule S, users C1-C4 that are scheduled to take part in the event can be associated with room G10 during the event.

When hierarchical representation 102 comprises a larger geographic area such as a city, state, etc., some or all of user information C1-C4 and/or location information G1-G10 could be automatically obtained from a telephone directory, a 911 directory, a mailing list, a company directory, a government directory, etc. Further, in addition or alternative to zip code nodes G2-G3, hierarchical representation 102 could comprise a level having fire district nodes. This configuration could be used to readily distinguish which fire station should be contacted when an emergency event is detected. Still further, hierarchical representation 102 could comprise various hierarchical levels for a school district (e.g., school district nodes, school nodes for each school in the school district, and/or grade nodes for each grade in the school) that would enable parents to be contacted when an event occurs at a particular school district (e.g., vote for budget), a particular school (e.g., school closing early) and/or a particular grade (e.g., class trip canceled). When hierarchical representation 102 includes one or more school-based levels, user information C1-C4 can be obtained from student information provided to each school.

As noted above, user information C1-C4 can comprise information on one or more ways to contact the corresponding user. For example, contact information can include one or more of: a mailing address, a telephone number, an email address, and the like. When an event occurs and/or a communication is desired for one or more users, the contact information used to contact the corresponding user can be selected based on the reason that the user is being contacted. For example, if a user is being informed that he/she should evacuate a building, then the telephone number(s) can be first used in an attempt to quickly contact the user. However, if the user is being informed of an upcoming social event, a paper mailing or email communication may be preferred.

II. Overview of an Illustrative System

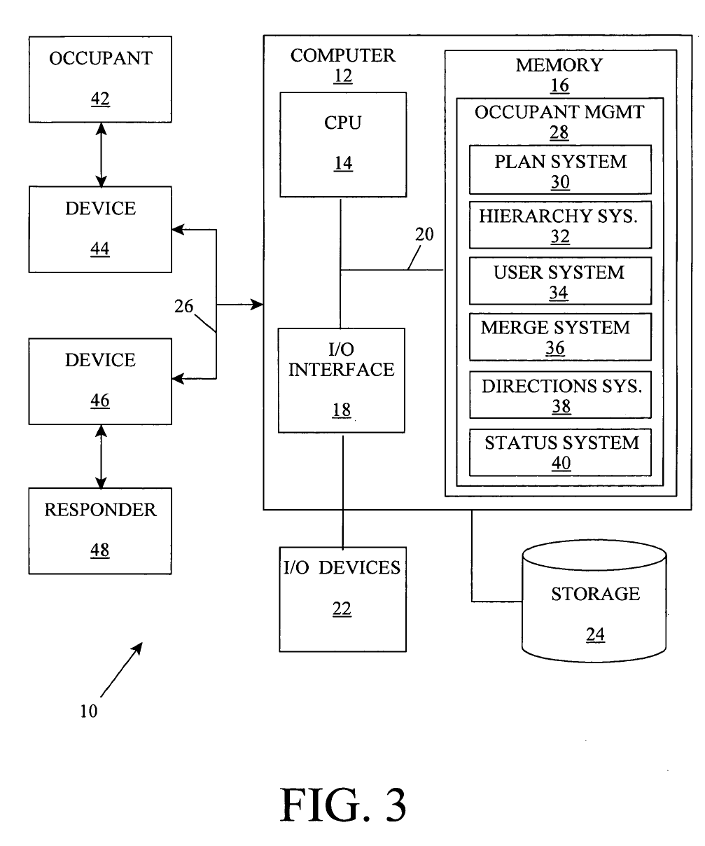

FIG. 3 shows an illustrative system 10 for managing occupants of a physical area (e.g., a building). In particular, computer 12 can obtain user information U1-U5 (FIG. 1) about an occupant 42 and/or other user such as an emergency responder 48, and store user information U1-U5 in, for example, storage unit 24. Further, user information U1-U5 can be associated with hierarchical representation 2 (FIG. 1) of the physical area that can also be stored in, for example, storage unit 24. Hierarchical representation 2 and associated user information U1-U5 can be used to provide information on the corresponding users (e.g., occupant 42 and/or responder 48) as discussed further below with reference to illustrative applications.

Users such as occupant 42 and/or responder 48 can access hierarchical representation 2 (FIG. 1) by using devices 44, 46 that communicate with computer 12 using a network 26. Further, devices 44, 46 can communicate with each other either directly over network 26 or using computer 12. To this extent, network 26 can comprise any type of communications link. For example, some or all of network 26 can comprise an addressable connection in a client-server (or server-server) environment that may utilize any combination of wireline and/or wireless transmission methods. In this instance, computer 12 and devices 44, 46 may utilize conventional network connectivity, such as Token Ring, Ethernet, WiFi or other conventional communications standards. Further, network 26 can comprise any type of network, including the Internet, a wide area network (WAN), a local area network (LAN), a virtual private network (VPN), a wireless network, etc. Where computer 12 and/or devices 44, 46 communicate via the Internet, connectivity could be provided by conventional TCP/IP sockets-based protocol, and one or more of computer 12 and devices 44, 46 could utilize an Internet service provider to establish connectivity.

As shown, computer 12 generally includes a central processing unit (CPU) 14, a memory 16, an input/output (I/O) interface 18, a bus 20, external I/O devices/resources 22, and a storage unit 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Storage unit 24 may comprise any type of data storage for providing storage for information necessary to carry out the invention as described herein. As such, storage unit 24 may include one or more storage devices, such as a magnetic disk drive or an optical disk drive. Moreover, similar to CPU 14, memory 16 and/or storage unit 24 may reside at a single physical location, comprising one or more types of data storage, or be distributed across a plurality of physical systems in various forms. Further, memory 16 and/or storage unit 24 can include data distributed across, for example, a LAN, a WAN or a storage area network (SAN) (not shown).

I/O interface 18 may comprise any system for exchanging information to/from one or more external I/O devices 22. I/O devices 22 may comprise any known type of external device, including speakers, a CRT, LED screen, handheld device, keyboard, mouse, voice recognition system, speech output system, printer, monitor/display, facsimile, pager, communication hardware/software, etc. Bus 20 provides a communication link between each of the components in computer 12 and likewise may comprise any known type of transmission link, including electrical, optical, wireless, etc.

It is understood that computer 12 is only an illustrative representation of a computing device. As a result, various combinations of components may be incorporated into computer 12. It is also understood that devices 44, 46 typically include the same elements as shown in computer 12 (e.g., CPU, memory, I/O interface, etc.). These have not been separately shown and discussed for brevity. Further, it is understood that each computer 12 and device 44, 46 comprises any type of computing device capable of communicating with one or more other computing devices, such as a server, a desktop computer, a laptop, a handheld device, a mobile phone, a pager, a personal digital assistant, etc. However, it is understood that if computer 12 or a device 44, 46 is a handheld device or the like, a display could be contained within computer 12 or device 44, 46, and not as an external I/O device 22 as shown and described in FIG. 3.

Computer 12 is shown including an occupant management system 28 that manages occupants of a physical area. Various systems included in occupant management system 28 can carry out the method steps shown in FIG. 2 and described above with reference to FIG. 1. For example, occupant management system 28 is shown including a plan system 30 that can obtain a plan of a physical area, such as building plan 4 (FIG. 1), as described with reference to step G1 (FIG. 2). Occupant management system 28 is also shown including a hierarchy system 32 that can generate a hierarchical representation of the physical area, such as hierarchical representation 2 (FIG. 1), as described with reference to step G2 (FIG. 2). Further, occupant management system 28 is shown including a user system 34 for obtaining user information such as user information U1-U5 (FIG. 1) and a corresponding area of the physical area as described in steps G3-G4 (FIG. 2), and a merge system 36 for associating the user information with hierarchical representation 2 as described in step G5 (FIG. 2).

As will be discussed further below, hierarchical representation 2 (FIG. 1) and associated user information U1-U5 (FIG. 1) can be used in various applications. For example, hierarchical representation 2 can be used to obtain directions from an occupant's location to another location within the physical area. To this extent, occupant management system 28 is shown including a directions system 38. Further, hierarchical representation 2 can be accessed to determine a location of one or more occupants. To this extent, occupant management system 28 is shown including a status system 40 for obtaining a status (e.g., location, health) of one or more occupants 42. It is understood that the various systems shown implemented as part of occupant management system 28 are only illustrative systems. As a result, additional or fewer systems could be implemented based on the desired functionality. Further, one or more systems could be combined and/or split into separate systems that provide the same functionality. Still further, it is understood that devices 44, 46 could also include one or more systems that provide functionality for the current invention.

III. Applications

A. Directions and Contact Information

Returning to FIG. 1, the information stored at each area node H11-H7, and in user nodes U1-U5 can vary based on the application in which hierarchical representation 2 is used. In one application, directions system 38 (FIG. 3) can use hierarchical representation 2 to provide custom directions for an occupant 42 (FIG. 3) to move from a particular starting location to a destination location. In this case, each area node H1-H7 can include information on the exit(s) for the corresponding physical area, and can include directions from each exit for the area to each entry point for the area represented by its parent area node H1-H7. In this manner, directions can be efficiently combined using hierarchical representation 2 to generate directions from any starting location to any destination location.

For example, occupant 42 (FIG. 3) may correspond to occupant information U2, and be located in the area represented by sub-area node H7. Further, occupant 42 may desire directions from his current location to an area on the floor corresponding to floor node H3. In this case, hierarchical representation 2 can be used to obtain directions from sub-area node H7 to an entry point for floor area node H4, and from the entry point for floor area node H4 to an entry point for floor node H2 (e.g., an elevator or a staircase). These directions can be combined with directions from a corresponding entry point for floor node H3 to the destination area located on the floor corresponding to floor node H3. Further, if occupant 42 desires to use a particular entry point/exit area (e.g., stairs), then the directions can be readily customized to use the particular entry point/exit area. As is readily apparent, numerous possible routes may be selected. To efficiently select a short route, the directions to each entry point can be sorted from shortest to longest. Further, information such as distance and direction (e.g., compass direction) can be included in the directions. Various algorithms can be used to provide an efficient set of directions and remove any backtracking that may be included in the originally generated directions.

In generating directions for an occupant 42 (FIG. 3), directions system 38 (FIG. 3) can use the area node H1-H7 with which occupant 42 is associated as a default starting point. However, occupant 42 can be allowed to select any starting point. In selecting a destination point, a list of common destinations (e.g., bathroom, receptionist, building exit, conference room, etc.) can be presented to occupant 42 for selection. Further, occupant 42 can select a destination point by selecting another occupant's name, entering an office number, selecting an area on building plan 4, etc. Still further, occupant 42 can browse area nodes H1-H7 and their corresponding areas to determine the name of an occupant 42 in a particular office or the like.

To this extent, occupant information U1-U3 can include the name of the corresponding occupant 42 (FIG. 3). Contact information such as information for one or more handheld devices, mobile telephones, home telephones, email addresses, and/or pagers, a home address, etc., can also be included as occupant information U1-U3 and/or as one or more child nodes of occupant information U1-U3, such as device node D1. Further, occupant information U1-U3 and/or one or more child nodes could include a present/absent status indicating whether the corresponding occupant 42 is present within the building, logged into a network, etc. In this case, a user can determine which contact information may be successful in contacting the occupant 42. For example, when a status indicates that occupant 42 is currently available on a computer network, the user could attempt to contact occupant 42 using his/her email address.

Similarly, user information U4-U5 and/or one or more child nodes that are associated with portions of the physical area can also include some or all of the contact information stored in occupant information U1-U3. User information U4-U5 can also include information that identifies the one or more situations in which the corresponding user should be contacted. In this manner, a user can select the appropriate user that should be contacted based on the current situation, and also efficiently obtain the contact information for the user.

One or more area nodes H1-H7 could also include contact information for the corresponding area. Alternatively, this information could be included in one or more child nodes of an area node H1-H7 as shown with device node D1. For example, sub-area node H6 could correspond to an office. As a result, telephone information such as an extension number for the office, computer information such as a network address for a network outlet located in the office, and the like can be stored in area node H6 or a child node. In this case, when a user seeks to contact occupant 42 (FIG. 3), contact information stored in both the occupant information U1-U3 for occupant 42, and the area node H1-H7 corresponding to the location of occupant 42 can be provided to the user. Other contact information can also be included in one or more area nodes H1-H7. For example, information on an intercom installed in an area could be associated with the corresponding area node H1-H7. When the user associated with user information U4-U5 is an occupant of the physical area, the contact information for the user's location can also be provided to a user. It is understood that when the user is not an occupant of the physical area, his/her personal contact information could include contact information for his/her location (e.g., office telephone number). As a result, various options for contacting a particular occupant or other individual related to a physical area can be readily stored and retrieved using hierarchical representation 2.

B. Emergency Response

When an emergency event occurs, hierarchical representation 2 (FIG. 1) and/or occupant management system 28 (FIG. 3) can assist in communicating with and providing assistance to occupants 42 (FIG. 3). To this extent, it is understood that some or all of occupant management system 28 can be implemented and/or duplicated in a location that is away from the physical area (e.g., building) that is represented in hierarchical representation 2. This provides additional assurance that occupant management system 28 will continue to provide functionality during the emergency event. An emergency event may be automatically detected by occupant management system 28 using a smoke detector, hazardous material detector, an earthquake sensor, a burglar alarm, or the like, and/or the occurrence of an emergency event (e.g., a heart attack) can be manually entered by an occupant 42 or another user. In any event, occupant management system 28 can assist in obtaining various information about occupants 42 and/or providing various information to occupants 42 and/or responders 48 (FIG. 3).

Hierarchical representation 2 (FIG. 1) can be used to obtain information on occupants 42 (FIG. 3) and/or establish two-way communication between occupant 42 and one or more emergency responders 48 (FIG. 3). For example, responder 48 may comprise a co-worker of occupant 42, and occupant 42 may require emergency assistance. In a typical office, co-workers generally communicate face-to-face, by telephone extension, and/or by email. However, should responder 48 be away from his/her office, each of these modes of communication may fail. Directions system 38 (FIG. 3) can obtain user information U4 (FIG. 1) for responder 48 using hierarchical representation 2, and can provide contact information for a mobile device 46 (FIG. 3) or the like for responder 48. As a result, communication between responder 48 and occupant 42 and/or other occupants 42 capable of providing assistance may be quickly commenced. Two-way communication between occupant 42 and a non-occupant responder 48 also can be established in the same manner.

Status system 40 (FIG. 3) can be used to obtain status information for one or more occupants 42 (FIG. 3) during an emergency event such as a fire that requires evacuation of a building. In particular, information about the location of occupant 42, whether occupant 42 is injured, whether occupant 42 is safe or evacuating, etc. can be obtained during an emergency event. To this extent, the directional information stored in area nodes H1-H7 (FIG. 1) and/or contact information stored in user information U1-U5 (FIG. 1) and the functionality provided by directions system 38 (FIG. 3) can be used by status system 40. The status information can be compiled and provided to one or more emergency responders 48 (FIG. 3). As a result, responder 48 can make more informed decisions about what action to take in responding to the emergency event.

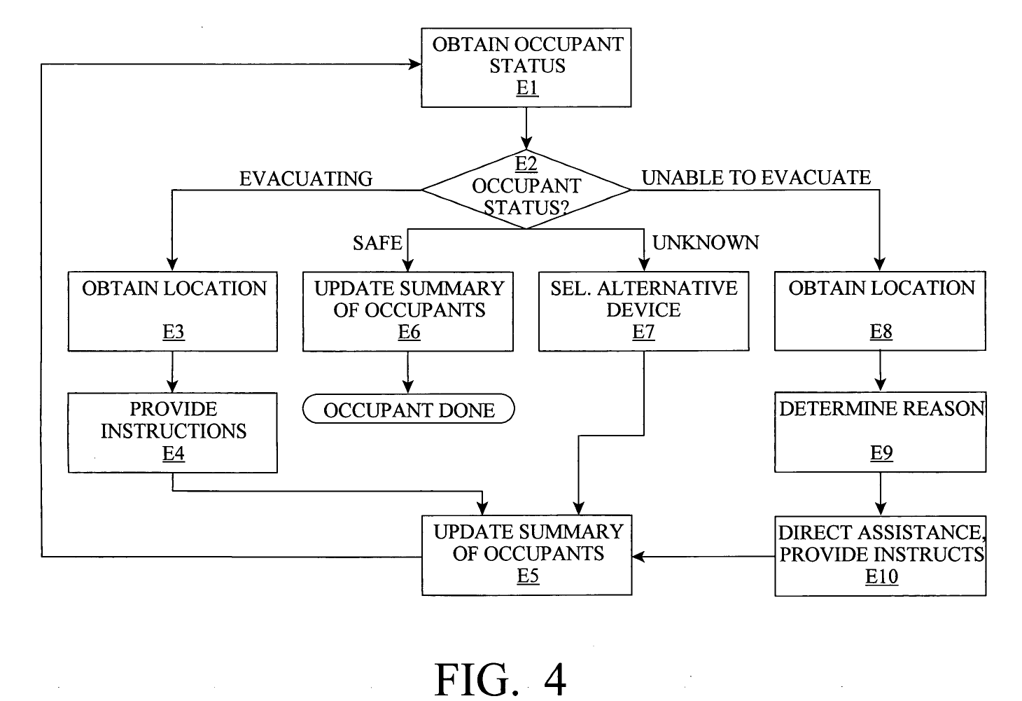

FIG. 4 shows various method steps that can be carried out by status system 40 (FIG. 3) for each occupant 42 (FIG. 3) of a building during an evacuation. In step E1, a status of occupant 42 can be obtained. For example, directions system 38 (FIG. 3) can be used to obtain a location and contact information for occupant 42. One of the various methods of contacting occupant 42 can be selected, and a message can be sent using the selected method. The selected method for contacting occupant 42 can be based on an anticipated robustness of the communications medium, and/or the known or anticipated location of occupant 42. For example, when occupant 42 has not previously logged onto a company network during the day, an initially selected communications method could comprise a mobile telephone. The number could be dialed and a recorded message could request that occupant 42 indicate his/her status. Occupant 42 could select his/her status from a list of possibilities by speaking a number or phrase, entering a number on the mobile telephone, or the like. In one embodiment, possible selections comprise evacuating, safe, or unable to evacuate. If the selected communications method fails to contact occupant 42, occupant 42 can be assigned an unknown status.

In step E2, one of various alternatives are selected based on the status of occupant 42 (FIG. 3). When occupant 42 indicates that he/she is evacuating, processing flows to step E3, in which a location of occupant 42 is obtained. The location can be obtained using any of a variety of methods. For example, occupant 42 can enter his/her location manually or verbally using device 44 (FIG. 3), the location can be automatically determined by determining the location of device 44 (e.g., computer in an office or a wireless device using a particular wireless receiver), or the like.

After determining a location of occupant 42 (FIG. 3), in step E4, status system 40 (FIG. 3) and/or responder 48 (FIG. 3) can provide one or more instructions to occupant 42. For example, status system 40 can provide directions to the nearest exit and/or an alternative exit. Further, responder 48 can direct occupant 42 to a location at which he/she can receive assistance in evacuating the building. In either case, it is understood that directions system 38 (FIG. 3) can generate the directions that are provided to occupant 42 based on a starting point (e.g., current location of occupant 42) and a selected destination point (e.g., emergency exit).

In step E5, a summary of the status of all occupants 42 (FIG. 3) is updated. The summary can indicate the total number of occupants 42 currently in the building, the number of occupants 42 that have been contacted, the status of occupants 42, and/or the location of occupants 42. As discussed further below, the location and/or number of occupants 42 that require assistance can also be displayed. This information can be displayed on personal device 46 (FIG. 3) for responder 48 (FIG. 3), on device 46 located on a response vehicle, etc. As a result, responder 48 can make more informed decisions about the appropriate actions that should be taken.

After the summary is updated, flow returns to step E1, in which a status for occupant 42 is again obtained. In one embodiment, a status can be updated after a certain amount of time has passed (e.g., one minute) until occupant 42 indicates that he/she is safe. When occupant 42 (FIG. 3) indicates that he/she is safe, flow proceeds to step E6, in which the status summary is updated that occupant 42 is safe. At this point, no more communications are required for occupant 42. However, a location could be obtained (e.g., street location) and/or occupant 42 can be directed to a particular safe location.

When status system 40 (FIG. 3) is unable to contact occupant 42 (FIG. 3), the status of occupant 42 can be set to unknown. In this case, flow can proceed to step E7, in which alternative contact information, if available, is used to again attempt to contact occupant 42. For example, status system 40 could first attempt to contact occupant 42 using his/her mobile device 44 (FIG. 3), and then select an office telephone for the probable location of occupant 42 if communications with mobile device 44 fail. To this extent, information such as whether occupant 42 was available on a computer network (e.g., logged in to work account) or not can be used to help determine a possible location of occupant 42 and thereby select an appropriate option to use in attempting to contact occupant 42. In any event, flow proceeds to step E5 in which the summary of occupants 42 is updated, and returns to step E1 in which status system 40 again attempts to obtain a status for occupant 42.

If occupant 42 (FIG. 3) indicates that he/she is unable to evacuate, flow proceeds to step E8. In step E8, a location of occupant 42 is obtained as discussed above with reference to step E3. In step E9, occupant 42 can provide a reason as to why he/she is unable to evacuate. For example, occupant 42 may have been injured, thereby requiring assistance. Alternatively, all exit routes may be unusable. In step E10, assistance can be directed for occupant 42 and/or instructions can be provided to occupant 42 based on the provided reason. For example, occupant 42 could be directed to a particular location and/or given instructions on treating his/her injury until assistance can arrive. To this extent, one or more responders 48 that may be available and/or nearby can be directed to the location of occupant 42 to provide assistance.

Information obtained for each occupant 42 (FIG. 3) can be incorporated into hierarchical representation 2 (FIG. 1) to adjust instructions and/or directions provided to other occupants 42. For example, occupant 42 may indicate that an exit is blocked. Consequently, hierarchical representation 2 can be updated to reflect that a particular exit is blocked, and directions for all other occupants 42 can avoid using that exit. Further, numerous occupants 42 may be directed to an exit (e.g., from a conference room). In this case, other occupants 42 may be directed to alternative exits to avoid crowding at a particular exit. Similarly, an occupant 42 that is also a responder 48 (FIG. 3) can be directed to a location of another occupant 42 that requires assistance.

Still further, hierarchical representation 2 (FIG. 1) can include various other information on the building that can be used during an emergency event. For example, hierarchical representation 2 can include location information for emergency equipment such as a first aid kit, fire extinguisher, etc. Occupants 42 (FIG. 3) and/or responders 48 (FIG. 3) can be directed to this emergency equipment using hierarchical representation 2. Other building information such as the locations of windows can also be included. In this case, when occupant 42 indicates that no exit routes are available, directions system 38 (FIG. 3) can direct occupant 42 to a window or the like where a responder 48 may be able to evacuate occupant 42. Other building information such as the location of windows, water pipes, heating/cooling ducts, electrical wiring, network wiring, etc. can be included in hierarchical representation 2. This information can be used, for example, when occupants 42 are unable to be contacted using telephone and/or network connections to isolate where a problem is located.

During an emergency, data can quickly change, and additional events can occur. As a result, hierarchical representation 2 (FIG. 1) can include one or more directives that are preset depending on the type of emergency event. A directive can comprise one or more preset communications that are sent to a given location and/or occupant 42 (FIG. 3). For example, a directive can be associated with each area node H1-H7 for a fire emergency, an earthquake, or the like. When a fire is detected, the corresponding directive for each area node H1-H7 can be sent to each device associated with area node H1-H7 and/or each device associated with occupants 42 located at the corresponding location. The directives can comprise, for example, an evacuation order, directions to an exit route, safety instructions, etc. To this extent, each directive could interrupt any other activity being performed using the device. For example, a user may lose the ability to continue working on a document on a personal computer until the directive is answered. Further, directives can be used to obtain the status information of occupant 42 as discussed above.

IV. Predefined Response Plan

As discussed previously, the invention can further comprise a solution for responding to an emergency event that affects the physical area. Specifically, under the present invention, a response plan can be planned for one or more types of emergency events (e.g., personal injury, fire, earthquake, etc.). The response plan can include one or more response operations that are each associated with a responder, occupant, and/or area for the physical area. Each response operation can be implemented when the emergency event is identified to improve the response to the emergency event.

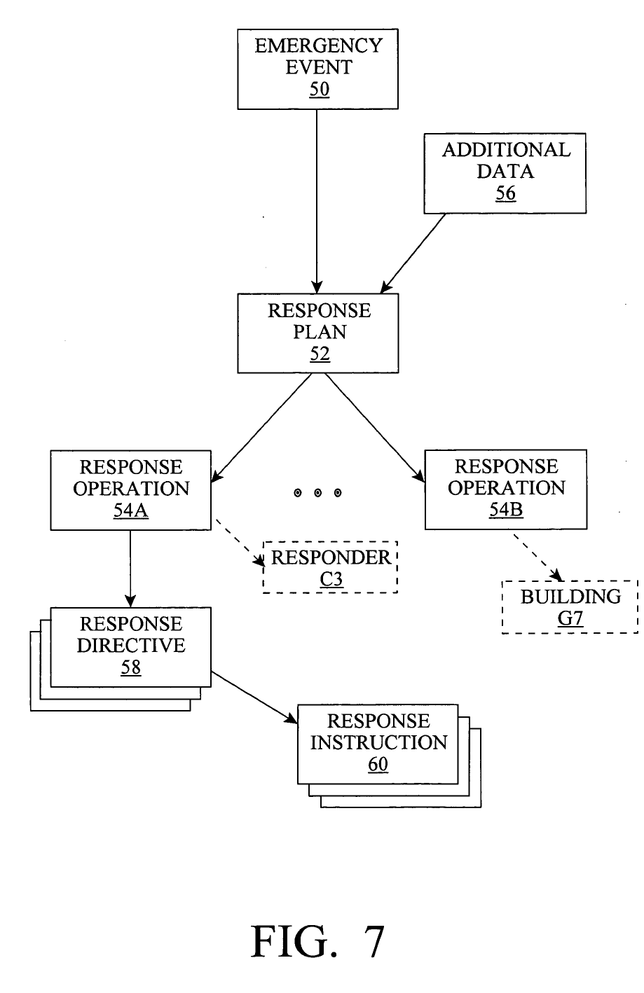

The response plan can include standard evacuation directions, directives for pre-assigned duties for emergency responders, and the like. To this extent, the response plan can be defined and stored in, for example, storage system 24 (FIG. 3). FIG. 7 shows an illustrative data relationship diagram that defines a response plan 52 for an emergency event 50. Emergency event 50 can comprise a definition of a unique emergency event (e.g., fire, heart attack, accident, etc.). In response to the identification of emergency event 50, response plan 52 can be triggered automatically or manually. For example, various sensors (e.g., fire, carbon monoxide, etc.) could detect one or more abnormalities within a physical area. The detected abnormality can then be compared to each defined emergency event 50 to locate one or more matching emergency events 50. Similarly, the occurrence of emergency event 50 could be input by a user, such as when an individual has a heart attack. In any event, once it has been indicated that emergency event 50 has occurred/is occurring, response plan 52 can be implemented.

Response plan 52 can include one or more response operations 54A-B. Each response operation 54A-B can comprise a particular response to emergency event 50. In an emergency, an appropriate response will vary based on a location and/or individual. To this extent, response operations 54A-B can be associated with one or more nodes in hierarchical representation 102 (FIG. 6). For example, in the case of a fire in the building represented by building node G7 (FIG. 6), response operation 54A could comprise a response provided to emergency responder/occupant C3 (FIG. 6) to determine if the fire can be put out, while response operation 54B could comprise a response provided to occupants of building node G7 to evacuate the building. Additional data 56 can be provided to adjust one or more parameters of response plan 52. For example, emergency event 50 could comprise a chemical spill. In this case, additional data 56 can comprise data on weather, heating/cooling systems in a building, information on the particular chemical, etc., and can be used to route the evacuation of individuals upwind of the spill, anticipate how the spill will spread, turn on/off various systems to obtain a desired air flow in a building, provide information to responders on appropriate protection/likely injuries, etc.

Each response operation 54A can include one or more response directives 58. A response directive 58 comprises information that is sent to a user. Response directive 58 can comprise instructions given to the user (e.g., evacuate using . . . , occupants unable to evacuate on floor . . . ) and/or a request for data (e.g., evacuation status). Additional response directives 58 can be sent to the user once a previous directive is acknowledged, responded to, and/or after a predetermined amount of time has elapsed. Each response directive 58 includes one or more response instructions 60. Each response instruction 60 comprises the actual data that is sent for the corresponding response directive 58. For example, a response directive 60 could comprise an instruction to evacuate the building. An appropriate response instruction 60 can be selected based on the device that will be used to send response directive. For example, if the device is an intercom, a response instruction 60 that comprises an audio file can be selected. Alternatively, if the device is a personal computer, a response instruction 60 that includes a visual indication of the evacuation route can be provided. Still further, for a mobile device, a short text message can be provided.

Response operations 54A-B, response directives 58, and/or response instructions 60 can be modified based on additional data 56. For example, response operation 54B can comprise predefined instructions for evacuating the area. However, additional data 56 could comprise information that one or more exit routes are unsafe. As a result, response operation 54B could be modified so that occupants are diverted from the unsafe exit. It is understood that multiple emergency events 50 can share one or more response plans 52. Similarly, multiple response plans 52 can share one or more response operations 54A-B. For example, evacuation response operation 54B could be shared by both fire and chemical spill response plans 52.

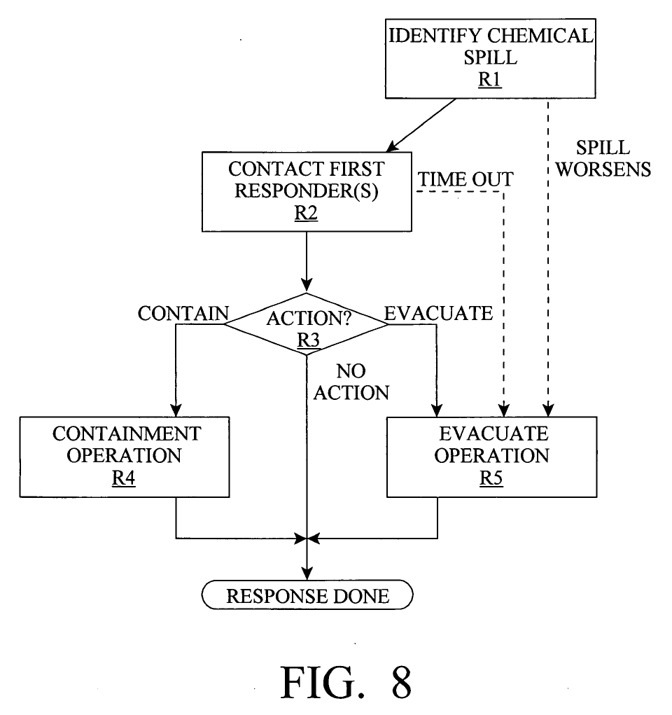

Response plan 52 can be implemented in a tiered manner. In particular, one or more response operations 54A-B may be implemented based on a result from a previous response operation 54A-B, in a certain subset of actual instances of emergency event 50 (e.g., occupant unable to evacuate), may only be implemented if a responder indicates that it is necessary (e.g., confirmation of break-in), and/or may be implemented based on particular additional data 56 (e.g., earthquake of certain magnitude). For example, FIG. 8 shows an illustrative method of responding to a chemical spill that occurs, for example, in the building represented by building node G7 (FIG. 6). In step R1, a chemical spill is identified, triggering response plan 52 (FIG. 7). Initially, in step R2, a response operation 54 (FIG. 7) is implemented that contacts responder C3 (FIG. 6) for his/her evaluation of the severity of the chemical spill. In particular, responder C3 can determine what is the appropriate action that should be taken and designate the action to occupant management system 28 (FIG. 3).

In step R3, occupant management system 28 (FIG. 3) waits to obtain manual feedback from responder C3 (FIG. 6) as to the appropriate action. For example, responder C3 could indicate that no action is required (e.g., a false alarm, small spill, etc.), and the response plan 52 (FIG. 7) will terminate. Alternatively, responder C3 could indicate that the spill can be contained. In this case, processing can continue to step R4, in which a containment response operation 54 (FIG. 7) is implemented. Containment response operation 54 could comprise contacting the fire department (e.g., station C2 in FIG. 6), other responders within the building, and/or partially evacuating the building. Still further, responder C3 could indicate that a physical area (e.g., block G4 in FIG. 6) should be evacuated. In this case, processing can continue to step R5, in which an evacuation response operation 54 is implemented. In an evacuation response operation 54, mayor C1 (FIG. 6) could be notified, along with several fire departments, police departments, hospitals, etc. Additionally, occupants C1-C4 (FIG. 6) could be provided directions to evacuate upwind of the spill, and/or to use alternative routes in an effort to decrease the amount of traffic on any one street.

Response plan 52 (FIG. 7) can also automatically implement tiered response operations 54A-B (FIG. 7). For example, if attempts to contact responder C3 (FIG. 6) in step R2 fail after a predefined amount of time (e.g., time out), processing can automatically continue to step R5 to implement an evacuation response operation 54. Similarly, if in step R1, an additional sensor detects the chemical spill indicating that it has spread beyond containment (e.g., additional data 56 in FIG. 7 changes), processing can automatically continue to step R5.

V. Sample User Interfaces

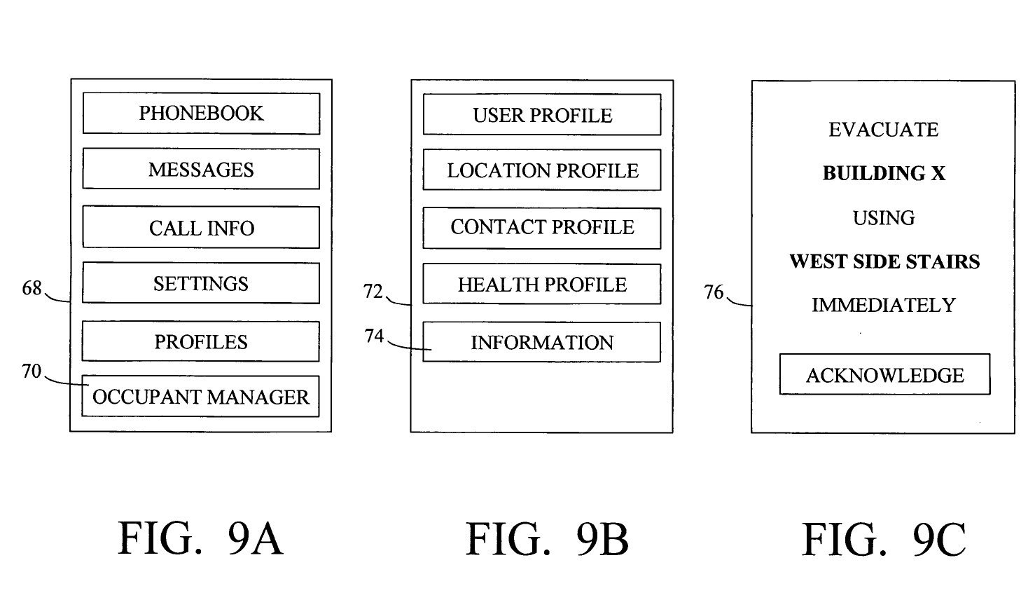

FIGS. 9A-I show illustrative user interfaces that can be displayed on device 44 (FIG. 3) to occupant 42 (FIG. 3). In general, device 44 can comprise a mobile telephone or the like that includes a display screen for displaying menus and the like. Further, device 44 can have program code loaded therein that comprises, for example, JAVA™ program code that provides support for interacting with occupant management system 28 (FIG. 3) using device 44. For example, as shown in FIG. 9A, device 44 can comprise a handheld device that displays an additional menu item 70 on a main menu 68. It is understood that various alternatives to menu item 70 are possible. For example, on a personal computer, one or more processes can execute continually execute in the background and/or have a link on a task bar to allow the device to communicate with occupant management system 28.

Menu item 70 can allow occupant 42 to interact with occupant management system 28. Once user selects menu item 70, an occupant management menu 72 can be displayed. Occupant management menu 72 allows occupant 42 (FIG. 3) to manage his/her data. In particular, occupant 42 can choose to display/edit a user profile (e.g., name, home address, home phone, etc.), a location profile (e.g., office location), a contact profile (e.g., emergency contact individual/information), and a health profile (e.g., disabilities, allergies, etc.). The data can be displayed and/or modified to occupant 42 in any known manner. Further, occupant 42 can select information menu item 74 to obtain information from occupant management system 28. For example, occupant 42 could obtain directions from one location to another, determine where another individual is located, review an emergency exit route, etc.

After an emergency event is detected, device 44 (FIG. 3) can display a message to occupant 42 (FIG. 3) informing occupant 42 of the emergency event and requesting that he/she acknowledge the message. For example, FIG. 9C shows an illustrative message 76 that informs occupant 42 to evacuate a building. As shown, message 76 can be given a higher priority than any other displayed data/operations that can occur on device 44. To this extent, occupant 42 can be prevented from continuing to use device 44 for any other purpose until message 76 is acknowledged and/or occupant 42 indicates that he/she is safe. Further, a response operation 54A-54B (FIG. 7) could provide additional information/directions to occupant 42. For example, FIG. 9D shows an illustrative evacuation menu 78 that can be presented to occupant 42 after he/she acknowledges message 76 (FIG. 9C). Evacuation menu 78 allows occupant 42 to indicate his/her evacuation status. For example, occupant 42 can indicate that he/she has evacuated and is safe, has evacuated but needs medical assistance, is currently evacuating, is evacuating and needs assistance, or is unable to evacuate.

As shown in FIG. 9C, message 76 can include directions that occupant 42 (FIG. 3) should follow to exit the building. The directions can comprise part of response operation 54B (FIG. 7), and can be associated with the location of occupant 42 (e.g., sub-area H7 in FIG. 1). In this manner, the directions can be quickly provided to occupant 42 without using substantial processing resources. However, additional data 56 (FIG. 7) may indicate that all or a portion of a predefined evacuation route is unsafe to use (e.g., blocked or overcrowded). In this case, response operation 54B can dynamically generate an alternative evacuation route using, for example, hierarchical representation 2 (FIG. 1) as discussed above. Alternatively, a responder U4 (FIG. 1) may provide alternative directions to occupant 42 so that responder U4 can provide assistance. In any event, FIG. 9E shows an illustrative message 80 that can be displayed to occupant 42 that designates an alternate exit route.

In addition to providing an evacuation status, occupant 42 (FIG. 3) could be requested to provide his/her location. To this extent, FIG. 9F shows an illustrative menu 82 that allows occupant 42 to quickly provide his/her location. In particular, occupant 42 can select a predefined location or send a message (e.g., text, audio, etc.) for his/her location. As shown in FIG. 9G, when occupant 42 indicates that he/she requires assistance, a menu 84 can be displayed that allows occupant 42 to select a predefined reason that assistance is required and/or send a message explaining why assistance is required. Similarly, when occupant 42 indicates that he/she is unable to evacuate, a menu 86 shown in FIG. 9H can be displayed to allow occupant 42 to indicate why he/she cannot evacuate.

As shown in FIGS. 9D-G, occupant 42 (FIG. 3) can also indicate when additional occupants are located with occupant 42. In this case, occupant 42 can designate how many others are with him/her. Additionally, FIG. 9I shows an illustrative screen 88 that can be presented to allow occupant 42 to identify one or more of the other occupants. For example, occupant 42 can enter in the other occupant's name, select from a list of other known occupants, identify the occupant by an alternative unique identifier (e.g., telephone number, employee identifier, email address), etc. If one or more of the other occupants are visitors, and are not known by occupant management system 28 (FIG. 3), then additional information such as a telephone number and emergency contact information for the other occupant could be provided. For each additional occupant, occupant 42 could also designate whether he/she requires assistance as shown in FIG. 9G.

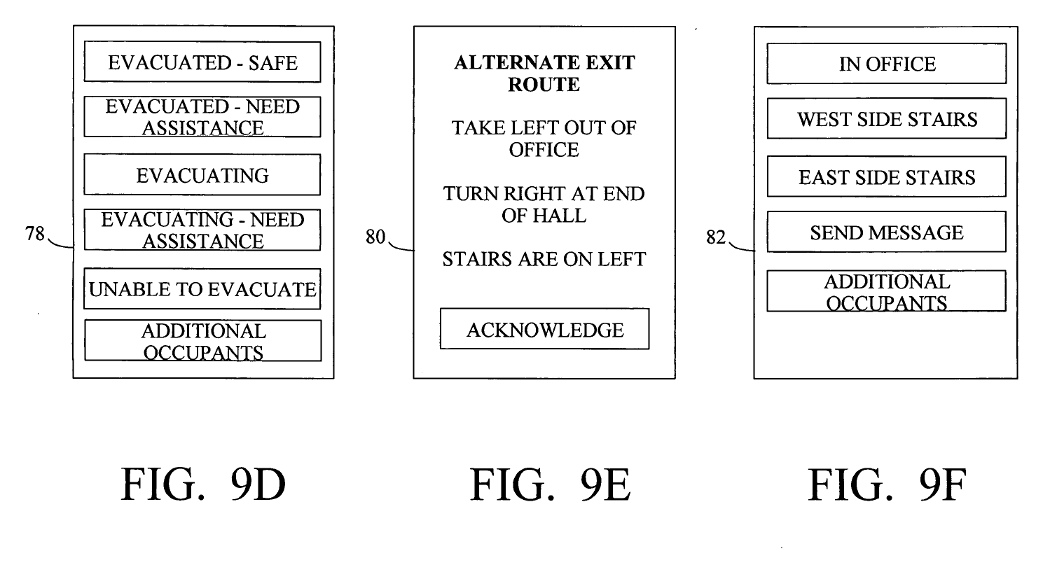

FIGS. 10A-C show illustrative user interfaces that can be displayed on device 46 (FIG. 3) to responder 48 (FIG. 3). In particular, FIG. 10A shows an illustrative menu 90 that can be displayed to responder 48 after an emergency event has been identified. As shown, responder 48 can select to view/edit information on the response plan, data on the emergency event itself (e.g., fire alarms that have been activated), a summary of the statuses for various occupants, locations of the responders, and/or choose to send a message to another responder and/or an occupant. Selection of any of the various choices can allow responder 48 to view data on the chosen item. For example, FIG. 10B shows a menu 92 that summarized the statuses of various occupants 42 (FIG. 3). In particular, menu 92 shows the number of occupants 42 that have not responded, have evacuated successfully, are currently evacuating, cannot evacuate, and/or require medical assistance. Based on this information responder 48 can make a more informed decision on how to respond to the emergency event. For example, as long as all occupants 42 are safely evacuating and/or have been evacuated, then there would be no need to send one or more responders 48 into danger searching for other occupants.

However, when one or more occupants 42 (FIG. 3) are unaccounted for, then responder 48 (FIG. 3) must determine an appropriate course of action. To further assist in this determination, responder 48 can obtain data on each occupant 42. For example, FIG. 10C shows an illustrative screen 94 that includes data on an occupant that has not responded. In this case, screen 94 can display an office location as well as the general hours that the occupant is at the office. Responder 48 can use this information to determine a likelihood that occupant 42 has been harmed, a risk of sending another responder 48 to determine a location of occupant 42, etc. For example, in this case, screen 94 indicates that the occupant was scheduled to be on vacation. Screen 94 also allows responder 48 to view additional data on occupant 42, route assistance to the location of occupant 42, view a map of the physical area, etc.

The illustrative screens shown in FIGS. 9A-I and FIGS. 10A-C along with occupant management system 28 (FIG. 3) can assist in readily establishing communications between occupant(s) 42 (FIG. 3) and responder(s) 48 (FIG. 3). For example, occupant 42 can communicate with a default responder 48 based on his/her location (e.g., floor, room, building, etc.). For example, as shown in FIG. 6, occupant C4 can be placed in communication with responder C3 since occupant C4 is located on floor G9. As a result, occupant C4 will not be required to select the appropriate responder 48 with which to communicate. To this extent, when occupant C4 provides his/her status using menu 78 (FIG. 9D), for example, the status can be communicated to a device for responder C3. Once received, responder C3 could be allowed to select the received data (e.g., occupant's name) to initiate verbal communications with occupant C4 (e.g., using a mobile telephone), respond with a text message, etc. Additionally, status information sent by occupant 42 could be sent to multiple responders 48, a central call center such as a 911 operator or the like, a web site, or the like for displaying to additional users.

It is understood that the various screens shown in FIGS. 9A-I, and FIGS. 10A-C are only illustrative. To this extent, additional screens and/or menus can be incorporated as part of the invention, and alternative or additional functions can be provided to responder 48 (FIG. 3) and/or occupant 42 (FIG. 3). Additionally, the illustrative screens are configured to fit on a small display space such as provided by a handheld device or the like. Alternatively, when additional display space is available (e.g., on a personal computer), a larger menu could be provided, graphics (e.g., a map) could be included, etc. Still further, for audio-only devices such as a mobile telephone, a series of prompts could be given that allow the user to respond orally.

VI. Overview of Second Illustrative System

To date, many emergency response systems propose the use of radio frequency identification (RFID), global positioning system (GPS), or other similar technology to assist in responding to an emergency. In particular, such technologies are deployed and/or used to quickly and automatically locate individuals. However, the use of these technologies raises serious privacy concerns for the individuals. Additionally, for RFID, the individual is required to carry an RFID chip that makes his/her presence in a physical area known. Further, RFID is expensive to implement since it requires the deployment of multiple RFID receiver devices and/or repeater devices due to the short transmission distances. For GPS, the accuracy provided is frequently insufficient. In particular, a typical error range can comprise plus or minus fifty feet. For a tall building, this can mean an error of up to five floors. As a result, these technologies are not desirable for implementing an emergency response system.

Using the features described herein, an emergency response system can be generated that improves on the proposals that use the tracking technology. In particular, an improved response management system can be generated that incorporates one or more of the following features: no tracking of the movement of individuals; individuals voluntarily communicate their presence/location; provides emergency procedures, maps, and the like, to individuals; makes available, when necessary, physiological and/or injury information for individuals; enables communication between occupant(s) and responder(s); and/or other benefits as will be understood from the description herein. Further, the response management system can use ubiquitous and highly effective transmission methods such as mobile communications devices and the Internet, can be integrated with scheduling systems for individuals and/or task management for the responders, can be provided with emergency contact information for individuals, and the like, to provide additional functionality and benefits. To this extent, the response management system can be used at various structures, locations, and at particular events such as a parade, without requiring private information from the individuals present. Overall, the response management system provides the individual(s) and/or responder(s) with more privacy, information and power than other solutions that merely track evacuation status.

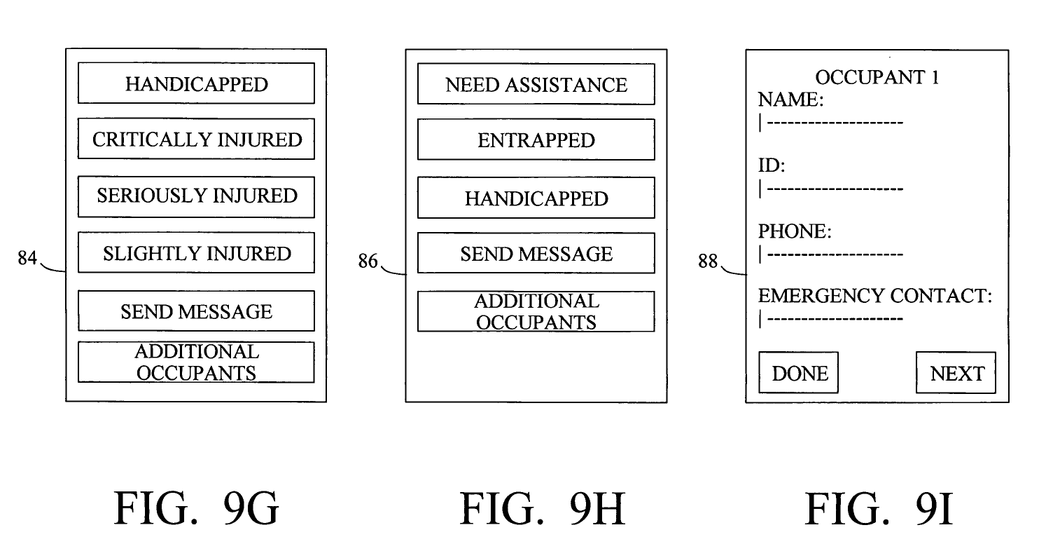

FIG. 11 shows a second illustrative system 10A for managing an occupant of a structure, and in particular, managing the occupant during an emergency event for the structure, such as one requiring evacuation. To this extent, similar to system 10 (FIG. 3), system 10A includes a computer infrastructure 11 that can perform the various process steps described herein for managing the occupant. In particular, computer infrastructure 11 is shown including a computing device 12 that comprises a response management system 100, which enables computing device 12 to manage the occupant by performing the process steps of the invention.

System 10A can comprise a particular embodiment of system 10 (FIG. 3) that is configured to manage an occupant of a structure during an emergency event. To this extent, the various systems shown in system 10A can incorporate some or all of the functionality shown and described above with reference to system 10 in implementing the functionality described herein. While primarily shown and described as managing one or more occupants of a structure, it is understood that system 10A could manage occupants for a plurality of structures (buildings, stadiums, etc.) and/or a plurality of geographic areas.

Regardless, computing device 12 is shown including a processor 14, a memory 16, an input/output (I/O) interface 18, and a bus 20. Further, computing device 12 is shown in communication with an external I/O device/resource 28 and a storage system 24. These components are the same as those described above with reference to FIG. 3. To this extent, as is known in the art, in general, processor 14 executes computer program code, such as response management system 100, that is stored in memory 16 and/or storage system 24. While executing computer program code, processor 14 can read and/or write data, such as occupant profile 120, to/from memory 16, storage system 24, and/or I/O interface 18.

In any event, computer infrastructure 11 is only illustrative of various types of computer infrastructures for implementing the invention. For example, in one embodiment, computer infrastructure 11 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques.

Further, computer infrastructure 11 can be in communication with and facilitate communication between one or more user devices such as a call center 47, an occupant device 44, a responder device 46, and/or an administrator (admin) device 49. Each of these devices 44, 46, 47, 49 is shown in communication with computing device 12 and/or one another over a communications link 26. As discussed above, communications link 26 can comprise any combination of various types of communications links as is known in the art. Further, any of various communication protocols can be used in the communications, including, for example, a telephone call that uses a wired and/or wireless public network; an Internet message that uses an Internet protocol such as TCP/IP, voice over IP, HTTP, or the like; a text message that comprises an electronic mail, file transfer protocol (FTP), or the like; etc. When a telephone call and/or voice over IP is used, information can be audibly communicated and/or touchtone menu options can be presented and selected by a user. In either case, text data can be automatically synthesized to speech and/or vise versa. For example, in one embodiment, computer infrastructure 11 can comprise a centralized server, such as a web server, with which devices 47, 49 (e.g., desktop computers) communicate via the Internet, while devices 44, 46 (e.g., personal wireless communication devices such as a mobile phone, a personal digital assistant (PDA), or the like) communicate with computer infrastructure 11 via a wireless telephone network and/or the Internet. To this extent, in one embodiment, devices 44, 46 can provide information such as a user name, password, evacuation status, etc., to computer infrastructure 11 by concatenating the information to a particular web address/uniform resource locator (URL) for the computer infrastructure 11 in a known manner. In this case, faster synchronization and data transmission is achieved since the number of transmissions is reduced. It is understood that this is only illustrative and various alternatives are possible, for example, admin device 49 could comprise a personal wireless communication device rather than a desktop computer.

As previously mentioned and discussed further below, response management system 100 enables computing infrastructure 11 to manage one or more occupants of a structure, and in particular, manage the occupant during an emergency event for the structure, such as one requiring evacuation. To this extent, response management system 100 is shown including an administration system 102 for managing data used to manage the occupant, a registration system 104 that enables the occupant to register/be registered with response management system 100, a communication system 106 that enables communications between an occupant (using occupant device 44) and one or more other individuals such as a response coordinator at a call center 47 and/or a responder (using responder device 46), an evacuation system 108 that manages an evacuation of the structure, and an assistance system 110 that manages providing assistance to an occupant in need. Operation of each of these systems is discussed further below. However, it is understood that some of the various systems shown in FIG. 11 can be implemented independently, combined, and/or stored in memory for one or more separate computing devices that are included in computer infrastructure 11. Further, it is understood that some of the systems and/or functionality may not be implemented, or additional systems and/or functionality may be included as part of system 10A.

VII. Illustrative Functions

A. Administration

Administration system 102 enables one or more users, such as a building manager, personnel manager, or the like, to manage (e.g., add, delete, modify) occupant profile 120 and/or structure data 122. For example, as mentioned above, structure data 122 can be automatically generated based on one or more computer aided design (CAD) data files that comprise data on the design in three-dimensional and/or two-dimensional drawings of the structure and/or geographical area including the structure (e.g., company park with multiple buildings). To this extent, as discussed above, structure data 122 can comprise a hierarchy of nodes that includes various relationships between areas and sub-areas of the structure(s) including, a building, one or more floors of the building, one or more areas (e.g., rooms, hallways) of the floor, one or more sub-areas of each area (e.g., cubicles), etc.

Using structure data 122 and/or the original CAD data, administration system 102 can further generate one or more direction templates 124. To this extent, structure data 122 can comprise information on various obstacles, openings, destination points, etc., that are included in the structure. In one embodiment, administration system 102 breaks down the data for the structure into various components.

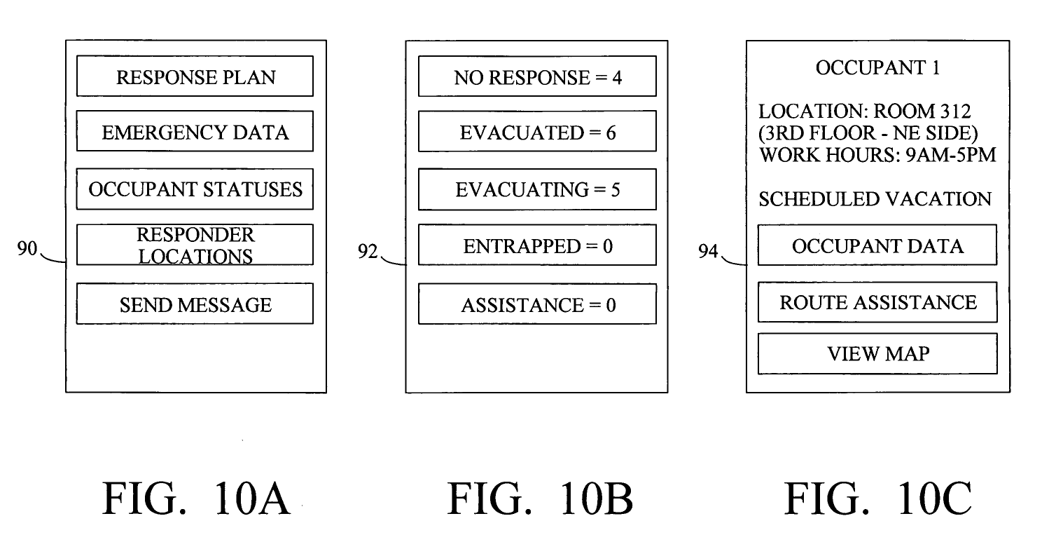

For example, each floor of a multi-story structure can be classified as a geometric plane with an X-axis and a Y-axis. To this extent, FIG. 12 shows an illustrative floor 200 of a structure. Referring to FIGS. 11 and 12, each axis can be scaled using any measurement system, and the origin (i.e., coordinate 0,0) can comprise the lower left corner of the floor 200's area. For a rectangular area, the X-axis can comprise one wall and the Y-axis can comprise another wall. The x, y coordinate values for each of the wall corners and the resulting line segment equations for each wall can be automatically obtained from the CAD data. Further, administration system 102 can automatically calculate the length/distance of each wall using this data. Similar information can be stored for each area 202A-D on the floor (e.g., room, corridor, cubicle, etc.). In any event, the data for each area can be stored as structure data 122.

Administration system 102 can also manage one or more destination points (D) for the structure in structure data 122. To this extent, administration system 102 can determine one or more destination points based on the CAD data. For example, a location of an emergency exit, a fire extinguisher, a first aid kit, stairs, a defibrillator, a fire escape, and the like, can be identified from the CAD data. Further, a user such as an administrator, can use administration system 102 to add/modify one or more of these destination points not defined in the CAD data and/or other destination points, such as a rendezvous point. Still further, administration system 102 can enable a user to identify various other components of egress, such as an area of refuge. In this case, administration system 102 can enable the user to draw the location on a map, enter the x, y coordinates that correspond to the area, or the like.

For each floor, administration system 102 can identify one or more obstacles 204A-D and store data for each obstacle 204A-D as structure data 122. An obstacle 204A-D comprises a physical element such as an interior wall, furniture, or the like, that would prevent an occupant from moving toward a desired destination point in a straight line. Administration system 102 can automatically identify an obstacle 204A-D from the CAD data, and/or a user can use administration system 102 to add, delete, modify, etc., one or more obstacles 204A-D. In either case, administration system 102 can determine the equation of the line segment that is between the two endpoints of each obstacle 204A-D.

Administration system 102 can further identify one or more openings 206A-D based on the obstacles 204A-D, which can be stored as structure data 122. An opening 206A-D is defined as a door, entrance, space, or the like between two or more obstacles 204A-D, through which an occupant can pass. For example, an opening 206A-D can be defined as an empty space wider than one foot. To this extent, each opening 206A-D comprises two endpoints (e.g., the endpoints of two obstacles 204A-D) that define its size and location. As a result, administration system 102 can automatically identify an opening 206A-D from the CAD data, and/or a user can use administration system 102 to add, delete, modify, etc., one or more openings 206A-D. For an area 202A-D defined by one or more curvilinear obstacles, a series of openings 206A-D can be defined by periodically (e.g., every ten feet) adding an opening 206A-D defined by the line segment for a minimum distance between two obstacles 206A-D that define the area 202A-D.

Administration system 102 can further manage structure data 122 that is calculated from other structure data 122. For example, administration system 102 can calculate and store a center point of each opening, which is defined as the midpoint between the two endpoints for the opening. Further, for a defined area (e.g., room, cubicle, etc.), a center point 208 can be calculated as the center of the area (e.g., by calculating the intersection of two lines joining the diagonally opposed corners of the area).

Structure data 122 can further comprise attribute data for one or more of the data items discussed herein. For example, administration system 102 can obtain occupied/unoccupied attribute data for one or more of the areas 202A-D discussed above. To this extent, administration system 102 can automatically obtain the data from the CAD data (e.g., data generated using a space management tool or the like). In this case, areas 202A-D such as walkways, corridors, common areas, waiting rooms, and the like could be classified as unoccupied, while areas 202A-D such as offices, conference rooms, hotel rooms, and the like could be classified as occupied. Further, for each opening 206A-D, administration system 102 can manage a passable status. For example, an opening 206A-D could be classified as active (passable), temporarily disabled (not passable), completely disabled (not passable), or the like. The status information can be manually entered by a user using administration system 102 and/or automatically obtained using one or more detectors/sensors for detecting a blockage of the passage that are in communication with administration system 102.

In any event, returning to FIG. 11, for each registered occupant (discussed below), administration system 102 can manage an occupant profile 120. As discussed previously, occupant profile 120 can comprise various information on the occupant such as his/her name, contact information, and, when possible, an assigned area such as an office, cubicle, room, etc. Additional information can be included in occupant profile 120 to provide further functionality for one or more applications. For example, personal information such as family contact information, health information (e.g., allergy, disability), and the like can be included. Further, information such as scheduled meetings, out of office plans, and the like can be included as and/or associated with occupant profile 120, and used to assist in locating an occupant that may not respond to directives and/or queries as discussed herein.

To this extent, administration system 102 can import data from a scheduling/calendar tool 130 used by the occupant and/or an administrator to generate a list of area/time frame pairs for each occupant based on his/her schedule. For example, a course scheduling system at a university could be used to generate an expected location of an occupant during the course of each course day. In this case, the assigned area would comprise a classroom and the time frame would be defined by the scheduled start and stop times for the course. Similarly, a calendar maintained by an occupant can be periodically synchronized with occupant profile 120 so that pre-scheduled meetings having a start time, location, and expected duration can be incorporated into the schedule data for occupant profile 120, and the assigned area for the occupant can be adjusted accordingly.

Alternatively, an occupant can manually provide his/her location using administration system 102, which then can be used as the assigned area. For example, the occupant can enter a street address for his/her current location, can click on a specific location in a map of the structure/geographic area displayed on occupant device 44, speak his/her location into occupant device 44, which is converted to data stored in occupant profile 120 using speech recognition software, can send a text message to administration system 102, use text messaging, or the like.

To this extent, in one embodiment, contact information for an occupant to communicate with response management system 100 can be posted throughout the structure. The contact information can comprise a web address, email address, telephone number, or the like. For example, the contact telephone number could comprise a special dialing code such as “#888” or the like, that would be easy for an occupant to remember (similar to 911). Further, the contact information can vary based on the structure and/or the different areas of the structure. For example, for the first floor of a structure, the dialing code could comprise “#888-1”. In the latter case, the assigned area of the occupant can be automatically obtained based on the contact information used, e.g., the number dialed. Similar modifications can be implemented for web addresses (e.g., “help.company.com”, “help.buildingfloor1.com”, etc.).

In any event, based on the assigned area 202A-D (FIG. 12) for the occupant, administration system 102 can map the occupant to a particular location (coordinate) within the structure. In one embodiment, a center point 208 (FIG. 12) for the assigned area can be used as the location point (L) for the occupant. Alternatively, when no assigned area is available, other data can be used to assign the location. For example, in the case of a public accommodation facility or geographic location (e.g. airport) the location of the occupant can be calculated by measuring a time duration for a radio signal to travel from the occupant device 44 to a wireless local area network (LAN) receptor (hotspot) in a known location. From the duration and known speed of the radio signal, a distance to the hotspot can be calculated. Based on this distance, the location (x, y coordinate) for the occupant can be determined.

Data can also be added to the occupant profile 120 during an emergency event. For example, information on an evacuation status of the occupant can be maintained and periodically updated. Similarly, information on an injury status of the occupant can be provided by the occupant to response management system 100 as discussed further herein.

B. Registration

Registration system 104 enables one or more occupants of the structure to be registered with response management system 100. To this extent, an occupant can register him/herself, be registered by an administrator, or the like. Further, registration system 104 can automatically register occupants based on CAD data imported from a space management tool or the like. In one embodiment, an occupant can register him/herself by contacting response management system 100 using a posted telephone number, email address, web address, or the like. In this case, registration system 104 can use information about occupant device 44 (e.g., email address, telephone number, or the like) to attempt to locate an occupant profile 120 for the occupant. If none is found, registration system 104 can prompt the occupant if he/she desires to be registered and/or desires to update his/her registration. In the former case, a new registration can be created and the occupant can provide information such as his/her name, location, and the like. In the latter case, the occupant can specify additional information (e.g., his/her name) that can be used to locate the corresponding occupant profile 120, which can be updated accordingly.

When an occupant is self-registering, the amount of and/or type of data requested by registration system 104 can vary based on whether the registration is occurring during an emergency event for the structure. In particular, when no emergency event is in progress, an estimated amount of time and/or expected location(s) within the structure, name, etc., can be obtained for the occupant. However, when an emergency event is occurring, information such as an evacuation status, injury status, or the like, can be requested by registration system 104.

Further, a registered occupant can use registration system 104 to provide information on one or more other occupants, such as a visitor, another occupant that cannot/does not wish to use his/her own occupant device 44, or the like. Regardless, registration system 104 can provide an option for the registered occupant to provide information on other occupants. The registered occupant can then enter various information that can be stored as an occupant profile 120 for the other occupants. The information provided can vary based on whether an emergency event is occurring. For example, when no emergency event is occurring, registration system 104 can prompt the registered occupant for the name of the other occupant, a duration he/she is expected to remain in the structure, his/her location, etc. When an emergency event is occurring, registration system 104 can request a number of other occupants and their injury/evacuation statuses. Further, registration system 104 can request information such as whether any of the other occupants are registered with response management system 100 (e.g., fellow employees). The latter information can assist in determining an accurate count of occupants (e.g., the other occupant(s) may be one or more not responding occupants).

A registered individual may or may not be currently in a structure. For example, all employees of a company may be registered with response management system 100, but all of the employees may not be present when an emergency event occurs. Further, an individual can use registration system 104 to “pre-register” with one or more structures/locations that he/she may frequent (e.g., a restaurant, an arena, a concert hall, a shopping center, and the like). In this case, a user can use occupant device 44 to contact response management system 100. If the user is not registered, registration system 104 can prompt the user to either register as an occupant and/or pre-register. In the latter case, registration system 104 can provide various contact information (e.g., phone number(s), web address(es), IP address(es), email address(es), and/or the like) for the structure for storage on occupant device 44. Further, the user can select to have an occupant profile 120 generated and stored for when the user will be present in the structure/location. Alternatively, the user can request not to have occupant profile 120 generated, in which case the user will need to subsequently register by again contacting response management system 100.

In addition, registration system 104 can provide a location system 112 to occupant device 44 that manages the information for various structures/locations for which the user has pre-registered. Further, for each structure/location, the user can designate an event that he/she will be attending (e.g., basketball games for a particular team that are played at the structure/location, upcoming concert, etc.). In this case, response management system 100 can automatically register the user as an occupant of the structure at the start of each event. Regardless, location system 112 can display structures/locations for which the user has pre-registered in a user-friendly manner (e.g., as a listing of the names of the structures/locations) and can contact response management system 100 based on a selected structure/location.

In this case, the user can request to contact response management system 100 by selecting the name of the structure/location. Subsequently, occupant device 44 will use the stored contact information to contact response management system 100 in a preferred manner. Once contacted, registration system 104 can prompt the user to register as an occupant in the same manner discussed above. Alternatively, location system 112 can periodically synchronize with a scheduling/calendaring tool 130 that also may be included on occupant device 44 to periodically automatically pre-register the user for a structure/location where he/she is scheduled to be in the near future. Still further, location system 112 could synchronize with a corporate/educational scheduling system located on another system in a known manner. In any event, once the time period(s) during which the user was scheduled to be at a particular structure/location has/have passed, location system 112 can automatically remove the contact information from occupant device 44 and/or response management system 100 can automatically remove the occupant profile 120 for the structure/location.

As noted previously, contact information for response management system 100 can be posted throughout the structure, such as one where many occupants are transient (e.g., an airport). By posting contact information for response management system 100, occupants can register with the system, if desired, while they are at the structure and/or when an emergency event occurs. In the latter case, an occupant that contacts response management system 100 without having been registered can be provided a menu of options, e.g., using a series of spoken prompts generated by registration system 104, to indicate his/her evacuation status and/or request emergency procedures (e.g., an evacuation route, precautions to take, etc.). In response, evacuation system 108 can provide any requested information to occupant device 44 based on contact information for the occupant device 44 obtained by, for example, caller identification. Additional information, such as a location of the occupant can be obtained based on the contact information used and/or provided to registration system 104 by selecting menu options, speaking/touch toning responses to requests for information, or the like. Once occupant device 44 is subsequently used to contact response management system 100, occupant device 44 can be automatically recognized based on its contact information, and evacuation system 108 (during an emergency event) and/or administration system 102 (when no emergency event is occurring) can interact with occupant device 44.

Additionally, registration system 104 can request/automatically obtain information on the service provider (e.g., mobile telephone carrier, Internet Service Provider) used by occupant device 44. This information can be used, for example, to obtain physiological information, emergency contact information, and the like, that was previously provided to the service provider. To this extent, a user can optionally provide such information to the service provider and its release can be limited to emergency responders after the occupant device 44 has been used to contact response management system 100. In one embodiment, response management system 100 can be implemented by the service provider, and therefore information on the occupant will be available once the occupant contacts response management system 100.

C. Evacuation

Evacuation system 108 can use direction templates 124 to automatically generate an evacuation route for an occupant. To this extent, evacuation system 108 can manage a set (one or more) of direction templates 124 that are based on structure data 122. Each direction template 124 can comprise a set of openings 206A-D (FIG. 12) through which an occupant at a given location L (e.g., an office) must pass in order to reach a destination point D (e.g., an exit). The set of openings 206A-D can comprise an ordered list of openings 206A-D, with each subsequent opening 206A-D comprising the next opening 206A-D that is directly accessible/reachable from the occupant's current location and/or the center point of a previous opening 206A-D in the set of openings 206A-D by moving in a straight line with no obstacle in between.

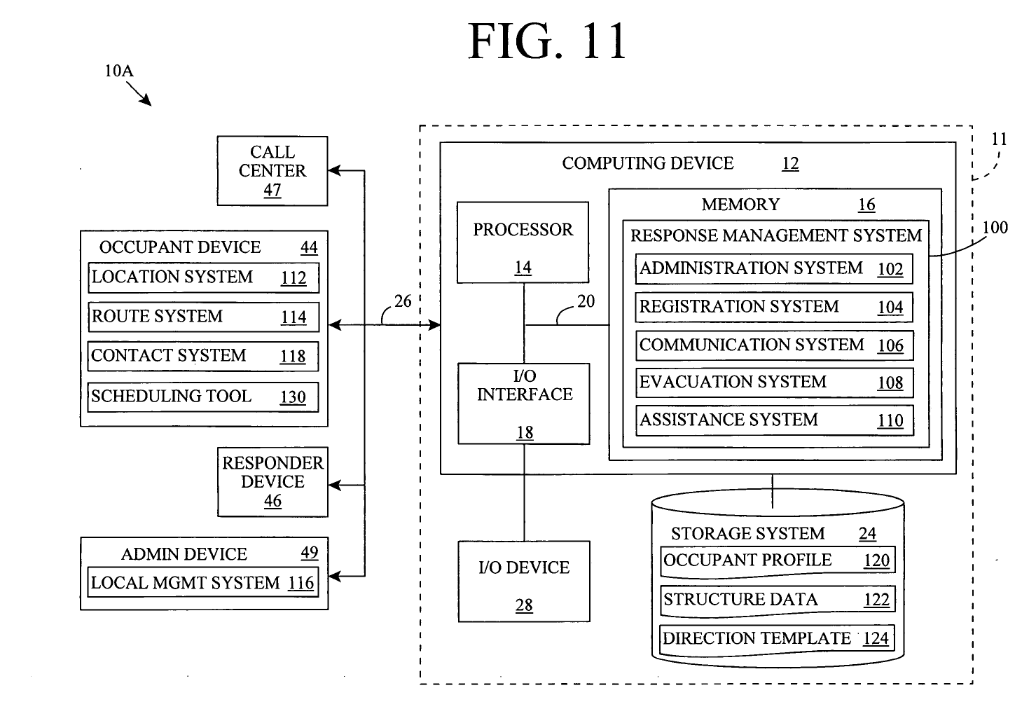

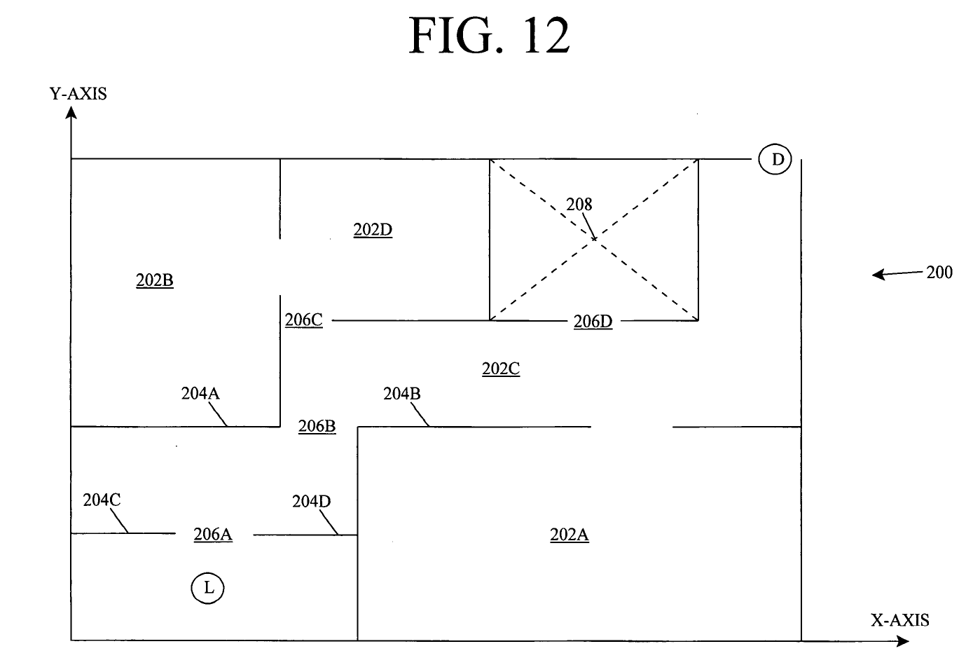

FIG. 13 shows illustrative method steps for generating an evacuation route. Initially, evacuation system 108 can generate direction templates 124 (step T). FIG. 14 shows illustrative method steps for generating a direction template 124, first, a starting point for the direction template 124 can be selected (step T I). In one embodiment, the starting point comprises the center point of an opening as discussed above. Alternatively, the starting point can comprise a potential location for an occupant (e.g., center point of each possible assigned area). Further, the destination point (e.g., emergency exit, first aid kit, etc.) for the direction template 124 is selected (step T2). Additionally, a straight line distance between the starting point and destination point can be calculated (step T3). In the case of a large geographic area where the straight line distance is greater than a maximum area size (e.g., one mile) a sub-area of the geographic area to be used in generating the direction template 124 can be defined (step T4). For example, the sub-area can be defined as a rectangle having the starting point and destination point as opposite corners. In this case, evacuation system 108 can only consider openings within the sub-area, thereby avoiding the need to determine all the openings within the entire geographic area.

Next, an ordered list of all the openings that the occupant could use to move from the starting point to the destination point is generated (step T5). In one embodiment, structure data 122 on the openings is used to generate the list of all of the available openings in the area (sub-area). In particular, each defined opening is selected, and a straight line distance between its center point and the starting point is determined. All of the openings are then placed on the ordered list from the closest to furthest from the starting point.

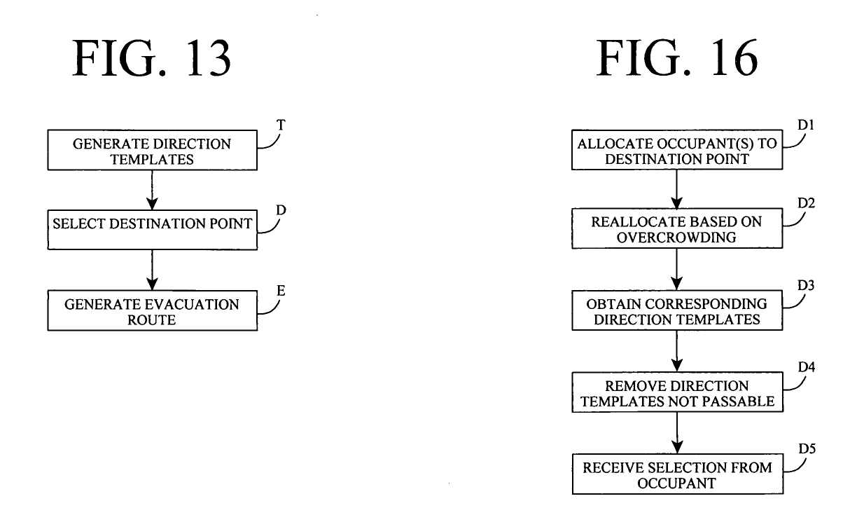

When structure data 122 does not include data on the openings, then evacuation system 108 must determine each of the next available openings. For example, FIG. 15 shows illustrative method steps for determining a next available opening. Initially, the two obstacle endpoints that are closest to the starting point are determined (step T5-1). To this extent, only endpoints that have a valid opening between them are considered. Next, it is determined if the intersection is valid (step T5-2). If the line representing an obstacle intersects with a plurality of other obstacle lines, then the intersection point closest to the starting point is chosen as a next possible opening. If the opening is not valid, that is, it is part of either obstacle or is outside the boundary of the area, then the next closest intersection is chosen as the next possible opening until all intersection points for the obstacle have been evaluated. This process is repeated for all obstacles until all intersections have been located.

Next, the width of each opening located can be calculated (step T5-3). In one embodiment, the shortest distance between the four endpoint pairs for the two obstacles can be used as the size of the opening. For example, if endpoints A and B belong to a first obstacle and endpoints C and D belong to a second obstacle, then the AC, AD, BC, and BD distances are calculated, and the smallest distance is used as the width of the opening. If the width of the opening is less than a minimum distance, e.g., one foot, then the opening is not classified as a possible opening. Next, evacuation system 108 can calculate the center point (x, y coordinate) of each opening as discussed previously (step T5-4), and each opening can be placed on the ordered list of openings sorted by the distance from the starting point (step T5-5).

In any event, for each opening on the ordered list, evacuation system 108 can create a sub-list of all the subsequent openings, i.e., the list of openings directly accessible from the current opening (step T6). This process is repeated for each sub-list, excluding the opening(s) already in a list, until the destination point is included in the sub-list or a dead end (no more subsequent openings) is reached. Each list that comprises a dead end can then be ignored. As a result, a set of lists is obtained, each of which includes the starting point as an initial location and the destination point as the final location.

Next, for each of these lists, evacuation system 108 can calculate a total distance (step T7). For example, evacuation system 108 can determine the cumulative distances between each location and the subsequent location in the list. Each of these lists and the corresponding distance can be stored as a direction template 124 for moving from a starting point to a destination point.

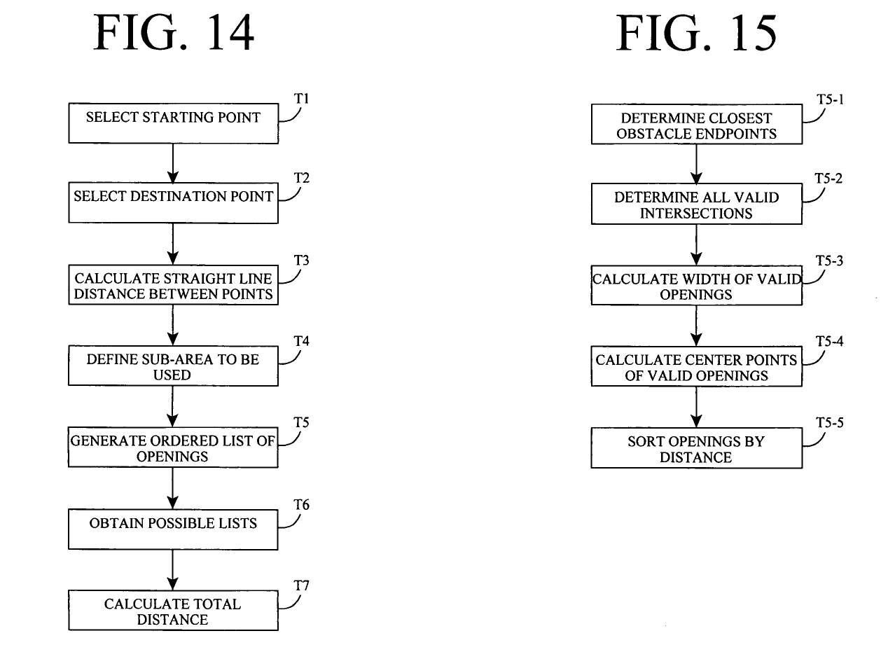

Returning to FIG. 13, in order to generate an evacuation route for an occupant using the direction templates 124, evacuation system 108 can determine an appropriate destination point for the occupant's location (step D). In one embodiment, three rules are applied. To this extent, FIG. 16 shows illustrative method steps for determining the destination point. Initially, if similar possible destination points exist for a given area to be evacuated (e.g., floor) evacuation system 108 can allocate an approximately equal number of occupants to each destination point (step D1). Subsequently, if multiple areas (e.g., floors) are being evacuated and are using the same destination points (e.g., stairways, exits, fire escapes, etc.), then occupants for one or more of the areas can be re-allocated to an alternative destination point to alleviate overcrowding (step D2). In particular, an aggregate number of occupants for multiple areas designated to each destination point can be determined and the values for the various destination points can be compared to each other and/or a maximum capacity value or the like. Any adjustments, if necessary, can then be made based on this comparison. This can be repeated until all destination points are within their maximum capacities.

Next, evacuation system 108 can obtain direction templates 124 from the occupant's location to the possible destination points (step D3). Further, evacuation system 108 can remove each direction template 124 that has a passable status that is not passable, e.g., includes an opening that is not passable (step D4). For example, evacuation system 108 can obtain the current passable status of each opening and remove any lists that include a currently impassible (e.g., temporarily or completely disabled) opening therein. When overcrowding and the like are not at issue, evacuation system 108 can order the destination points from closest to furthest and present them to the occupant for his/her selection (step D5). In one embodiment, the destination points are ordered based on the straight line distance between the occupant's current location and the destination point. Alternatively, the destination points can be ordered based on the shortest route from the occupant's current location to the destination point as stored in the direction templates 124.

In any event, returning to FIGS. 11 and 13, the evacuation template 124 that corresponds to the shortest route for the occupant to reach the destination point is used to generate a user friendly evacuation route for use by the occupant (step E). To this extent, evacuation system 108 can use preformatted text that are completed with variable data (e.g., direction, distance, location name, etc.), and can be provided to occupant device 44 as a text message or the like and/or used to generate a voice message that is played to occupant device 44. In particular, the evacuation route can comprise a total distance, directional and distance locations from one location to a subsequent location, and the like. To this extent, directional information can comprise absolute (north, south, east, west, etc.) and/or relative (left, right, forward, backward, etc.) information and can be readily determined by the assigned coordinates for the current and subsequent locations. Further, multiple evacuation routes can be provided for use by the occupant should one route not be passable or another route be preferable. Still further, additional data, such as a map showing the evacuation route or the like can be provided for display on occupant device 44 and/or printing by the occupant for later reference.

In one embodiment, evacuation system 108 can provide a set of direction templates 124 for storage on occupant device 44 based on the user's having “pre-registered” for the structure/location as discussed above. To this extent, the set of direction templates 124 can be selected based on an area of the structure in which the user is scheduled to be located. In this case, occupant device 44 can include a route system 114 that can generate one or more evacuation routes based on the direction templates 124 stored on occupant device 44 in the same manner as discussed herein with reference to evacuation system 108. This solution enables occupant device 44 to assist an occupant in an evacuation even when communications with response management system 100 are not/cannot be established. Once the time period for which the user is scheduled to be located within the structure, route system 114 can remove the set of direction templates 124 from storage on occupant device 44.

While occupant device 44 can be capable of independently managing the evacuation of the corresponding occupant, occupant device 44 should update response management system 100 with the status of the evacuation. Further, admin device 49 and/or occupant device 44 could comprise a local management (mgmt) system 116 that enables the evacuation to be initiated and/or managed without contacting response management system 100. To this extent, admin device 49 can be used by a security guard, floor warden, or the like, who can use local management system 116 to initiate and send an evacuation request to occupant device(s) 44 (e.g., via a text message) without the use of response management system 100. The local management system 116 allows the evacuation to be conducted when response management system 100 may be inaccessible, not readily accessible, and/or time is critical. The local management system 116 can track and receive evacuation information on the corresponding occupants for which the user is responsible (e.g., other occupants of floor).

In both cases, response management system 100 should be contacted regarding the start, progress, and/or conclusion of the evacuation. This enables other responders, emergency coordinators, and the like, to provide assistance and view the status of the occupant(s) via response management system 100. Additionally, the initiating individual can request that response management system 100 take over management of the evacuation. In either case, the mobile device 44, 49 can obtain the contact information for the response management system 100 based on the structure/location being evacuated, e.g., a URL/IP address for a dedicated web site, and can contact response management system 100, e.g., using an HTTP request that includes, for example, an indication of the area being evacuated, the evacuation status, and how the evacuation was started. Response management system 100 can then process the HTTP request to determine the current status. The mobile device 44, 49 can use similar functionality to indicate a change in evacuation status, the conclusion of an evacuation, and the like.

In any event, response management system 100 manages a set of response procedures for one or more emergency events. These response procedures can be particular to a structure/location (e.g., direction templates 124) and/or can comprise generic instructions (e.g., precautions to prevent exposure to a hazardous material). When the corresponding emergency event occurs, evacuation system 108 can automatically send the response procedures to each registered occupant expected to be present during the time period.

For unregistered occupants, response management system 100 cannot send the evacuation and/or response procedures to their occupant devices 44. In one embodiment, an unregistered occupant can use his/her occupant device 44 having a contact system 118 that can obtain contact information for response management system 100. For example, contact system 118 can receive location information for the occupant from the occupant, his/her calendar, or other information sources. Subsequently, contact system 118 can use preset contact information to contact a master system that maintains a set of all contact information for various locations. The contact system 118 can provide the location to the master system and the master system can respond with the contact information for the corresponding response management system 100. In one embodiment, the master system is implemented at a public call center 47 such as a 911 operator, police/fire station, or the like, or another mobile device, such as admin device 49, a responder device 46, or the like. To this extent, alternatively, occupant device 44 can provide status information for the occupant to the master system, which in turn can forward it to response management system 100.

D. Fire Code Compliance

The International Fire Code® (IFC), established by the International Code Council, the entirety of which is incorporated herein by reference, is intended as a comprehensive model fire code that establishes minimum regulations for safeguarding public health and safety from hazardous conditions due to fire, explosion, and the handling and/or use of hazardous materials. In one embodiment, the IFC is used as an input for evacuation system 108 in generating direction templates 124 and/or an evacuation route for an occupant. By using the IFC, evacuation system 108 can assist in ensuring that the evacuation procedures comply with the various guidelines, thereby helping to ensure that the generated evacuation route(s) will be as effective as possible.

Since one or more regional governments (e.g., nation, state, city, etc.) may implement its own fire code, evacuation system 108 can further determine a location of the structure and use the relevant regional fire code(s) as input. To this extent, when adding a structure, administration system 102 can prompt a user for the legal jurisdiction of the structure by, for example, selecting an option from one or more drop down lists. Once selected, evacuation system 108 will use the corresponding fire code as input when generating direction templates 124 and/or evacuation route(s).

Still further, administration system 102 can enable a user to select various parameters, constraints, exceptions, and the like for a particular structure rather than those of the IFC and/or a regional government. In this case, the user can be limited to specifying more stringent standards rather than relaxing those provided by the relevant fire code(s), if applicable, and/or can be prompted to confirm that a standard should be relaxed.

For example, administration system 102 can enable a user to select a type of occupancy for the structure. This selection can be used to set a parameter for the maximum floor area allowances per occupant (as defined by the IFC and/or another regional government), which will be used as an input for evacuation system 108. Administration system 102 can set various additional parameters based on the occupancy type, such as a maximum travel distance from an accessible space to an area of refuge, a size of a door, etc. In any event, administration system 102 can import various data from the IFC and use one or more algorithms to select the correct parameter based on the imported data. To this extent, administration system 102 can import the following table for the maximum travel distance for an occupant based on occupancy type and inclusion of a sprinkler system:

| | Without Sprinkler | With Sprinkler |
|---|---|---|
| Occupancy Type | System (Feet) | System (Feet) |
| A, E, F-1, I-1, M, R, S-1 | 200 | 250 |
| B | 200 | 300 |
| F-2, S-2, U | 300 | 400 |
| H-1 | Not Permitted | 75 |
| H-2 | Not Permitted | 100 |
| H-3 | Not Permitted | 150 |
| H-4 | Not Permitted | 175 |
| H-5 | Not Permitted | 200 |
| I-2, I-3, I-4 | 150 | 200 |

In this case, evacuation system 108 can use the corresponding maximum distance when calculating the evacuation routes and/or direction templates 124 and can limit, if possible, those provided to the occupant to the routes that conform to the maximum distance constraint. It is understood that this is only illustrative, and various additional regulations can be incorporated as will be recognized by one in the art.

The personalization of evacuation routes described herein (e.g., determining location of occupant and deriving set of evacuation routes for the location) enables response management system 100 to readily comply with the IFC and other guidelines. For example, evacuation system 108 can sum the number of occupants instructed to use a particular exit and/or evacuation route and can display a warning message and/or redirect occupants if a guideline is violated. Further, one or more occupancy types for a structure can be selected by a user, thereby allowing various guideline parameters to be applied that would otherwise not be known from the CAD data. Still further, an administrator/emergency planner can use administration system 102 to designate the use of certain parameters, which indicate how evacuation system 108 can comply with the IFC and/or other guidelines.

These various parameters, constraints, and exceptions dictate the evacuation routes generated by evacuation system 108. When one or more of these guidelines are violated, a warning message can be generated and communicated to an admin device 49, responder device 46, and/or call center 47. In response, the responders can allocate resources to assist the occupants for which these guidelines were violated since they may be in greater danger. Further, evacuation system 108 can automatically redirect occupants to use particular evacuation routes based on the conditions outlined by the guidelines.

E. Communication/Assistance

As discussed above, an occupant can use his/her occupant device 44 to obtain an evacuation route and/or provide his/her evacuation status from/to response management system 100 during an emergency event. Further, a call center 47, such as one or more 911 operators a fire chief, or the like, can communicate with response management system 100. For example, when a user notifies response management system 100 of an emergency event, response management system 100 can contact call center 47. Alternatively, an individual may contact call center 47 and inform them of the emergency event, and call center 47 can contact response management system 100 and activate the emergency response.

In any event, individuals at call center 47 can use assistance system 110 to view a report of the status information currently available for the occupant(s). The status information can include an injury status, an evacuation status, and the like. Assistance system 110 can generate various reports of the status information such as by sub-areas of the area being evacuated, by injury status, by evacuation status, and the like. As a result, call center 47 can quickly obtain headcounts of all occupants by evacuation status and injury status. This information can also be compared to a total capacity for the sub-area, a number of registered occupants for the sub-area, and the like.

An individual at call center 47 can then use assistance system 110 to redirect resources based on the information received from response management system 100. To this extent, call center 47 can contact a responder device 46 for an emergency responder, such as a firefighter, police officer, or the like, to request the direction of resources in a particular sub-area. For example, call center 47 may determine a particular sub-area has a lot of injured occupants and/or occupants not responding. In this case, additional resources can be redirected to the sub-area to assist occupants that may be located there. For a structure in which all or nearly all occupants are registered, once status information for all occupants is available and they are indicated as safe, call center 47 can further communicate with responder device 46 to indicate that the structure may be evacuated. Based on information from individuals at the scene, the responder may then make a determination to stop searching the structure for trapped occupants.

Additionally, each responder device 46 can be registered with response management system 100. In this case, assistance system 100 can further generate one or more reports for display at call center 47 indicating the status of the corresponding responder. For example, when a responder has been directed to assist one or more individuals in a sub-area, his/her status can be “assigned” and an indication of the sub-area can be included. Otherwise, the responder could be “unassigned” and an indication of a current location of the responder can be displayed. In this manner, an individual at call center 47 can readily determine the available personnel and allocate responders to particular sub-areas of need. Once the responder has completed his/her assignment (e.g., evacuated the occupant(s)), he/she can use responder device 46 to update his/her status to “unassigned,” and await a new assignment.

Additionally, a responder assigned to occupant(s) can contact an occupant device 44 using communication system 106. In particular, a responder can use his/her responder device 46 to communicate a message (e.g., a text message) via communication system 106 to occupant device 44. Alternatively, communication system 106 can provide the contact information for occupant device 44 from occupant profile 120 directly to responder device 46, and the responder can use the contact information to contact occupant device 44 directly. In this manner, the responder can be communicating with the occupant prior to reaching him/her thereby providing assurance to the occupant, obtaining additional information on the status of the occupant, obtaining information on the environment in the sub-area, and the like. The responder can use this information to request additional resources, redirect other responders, update a passable status of an opening, or the like. Once the responder has reached the occupant(s), the responder can use responder device 46 to update the status of the occupant(s) accordingly.

Various additional functionality can be provided by the invention. For example, similar to the occupants described above, evacuation system 108 can generate and provide directions to one or more responder devices 46 for use by a responder in reaching his/her assigned occupant(s). Additionally, when appropriate, an individual at call center 47 and/or a responder using a responder device 46 can obtain contact information for an emergency contact from occupant profile 120 for an occupant and contact the emergency contact to provide an update of the status of the occupant. It is understood that the functions described herein are only illustrative, and numerous alternative and/or additional functions can be provided as will be recognized by one in the art.

VIII. Alternatives

As noted previously, the invention can be implemented on a small scale, e.g., a house, or a large scale, e.g., a city or larger. In the former case, fire fighters responding to a house fire could be readily informed of the layout of a particular house, such as the location of a child's bedroom, potential sources of fire, etc. When used on a large scale, access to information can be limited based on the hierarchical representation 2 (FIG. 1). For example, an employee occupant 42 (FIG. 3) may only be able to view user information U1-U5 (FIG. 1) for co-workers. Further, the amount of user information (FIG. 1) that can be viewed may be limited by the identification of an occupant 42 as is known in the art. When multiple buildings are included in hierarchical representation 2, additional information such as directions to/from various locations (e.g., restaurants, shops, etc.) in the area can be available. To this extent, when a large scale emergency occurs that requires the evacuation of several buildings, occupants 42 can be given directions to alternative exit routes in the hope that traffic problems and the like can be lessened.

Further, the invention can be used to determine a best route for traveling from one location to another within a city, county, state, country, etc. In this case, a map of the corresponding geographic area can be imported into the invention from CAD data. In particular, street addresses within the geographic area can be assigned x, y coordinates with, for automotive directions, buildings, parks, and other similar objects mapping to obstacles; streets, highways, etc., mapping to openings; intersections of streets mapping to endpoints of openings; and the like. Location and destination point information can be obtained in the same manner as discussed above. To this extent, the invention can provide an alternative to current navigation systems based on satellite global positioning systems.

The invention can be used to develop an architectural design for a building and/or to approve the architectural design for construction. In particular, the invention can be used to automatically generate exit routes for various areas within the building and determine, for example, if one or more exit routes will suffer from overcrowding, one or more areas are not sufficiently close to an exit route, etc. Based on feedback from the invention, adjustments to the architectural design can be made and simulated, thereby providing a cost efficient solution to ensure that a new building conforms to the required governmental standards, and/or provides a safe environment for its occupants. To this extent, the invention can be used to simulate and prototype a proposed architectural design based on various potential emergency events (e.g., fire, shooting, natural disaster, etc.). As a result, the invention can assist in designing a new structure according to the most effective and efficient evacuation procedures. Further, an insurance actuarial or the like could determine a discount on the cost of insuring a building or the like that incorporates the invention. Additionally, the invention could be used to simulate exit routes and the like of an existing building or the like, and calculate an appropriate premium/discount based on the simulation results.

While primarily shown and described herein as a method and system for managing an occupant of a structure (e.g., building), such as during an emergency event, it is understood that the invention further provides various alternative embodiments. For example, in one embodiment, the invention provides a computer-readable medium that includes computer program code to enable a computer infrastructure to manage one or more occupants of the structure. To this extent, the computer-readable medium includes program code, such as occupant management system 28 (FIG. 3) and/or response management system 100 (FIG. 11), that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 16 (FIGS. 3 and 11) and/or storage system 24 (FIGS. 3 and 11) (e.g., a fixed disk, a read-only memory, a random access memory, a cache memory, etc.), and/or as a data signal traveling over a network (e.g., during a wired/wireless electronic distribution of the program code).

However, it is understood that computing device 12 (FIGS. 3 and 11) in conjunction with occupant management system 28 (FIG. 3) and/or response management system 100 (FIG. 11) are only representative of various possible equivalent computing devices that may perform the various process steps of the invention. To this extent, in other embodiments, computing device 12 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

In another embodiment, the invention provides a business method that performs the process steps of the invention on a subscription, advertising, and/or fee basis. That is, a service provider, such as an Internet Service Provider, could offer to manage one or more occupants of a structure as described above. In this case, the service provider can create, maintain, support, etc., a computer infrastructure, such as computer infrastructure 11 (FIG. 11), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for managing one or more occupants of a structure. In this case, a computer infrastructure, such as computer infrastructure 11 (FIG. 11), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 12 (FIGS. 3 and 11), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various embodiments of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of managing an occupant of a structure during an emergency event, the method comprising:
obtaining an emergency response management system for the structure prior to the emergency event;
establishing communications between the emergency response management system and a personal wireless communication device of the occupant;
obtaining location information for the occupant on the emergency response management system, wherein the location information is based on at least one of an occupant profile, contact information used in establishing communications, or a communication received from the personal wireless communication device via at least one of an Internet message, a text message, a selection of at least one menu option, or a verbal statement; and
providing the location information from the emergency response management system for use by a responder.

2. The method of claim 1, wherein the establishing step includes receiving at least one of an Internet message, a telephone call and a text message from the personal wireless communication device of the occupant.

3. The method of claim 1, further comprising registering the occupant with the emergency response management system, wherein the registering step includes generating an occupant profile for the occupant.

4. The method of claim 3, wherein the establishing step includes contacting the personal wireless communication device with at least one of an Internet message, a telephone call and a text message based on the occupant profile.

5. The method of claim 3, further comprising providing contact information for use by a personal wireless communication device for the responder.

6. The method of claim 1, wherein the providing step includes communicating the location information to an emergency response coordinator, wherein the emergency response coordinator selects one of a plurality of responders and communicates the location information for use by the selected responder.

7. The method of claim 1, further comprising obtaining evacuation status information for the occupant on the emergency response management system and providing the evacuation status information for use by the responder.

8. The method of claim 1, further comprising managing a plurality of evacuation route templates on the emergency response management system.

9. The method of claim 8, further comprising:
determining at least one evacuation route template for the occupant;
generating an evacuation route for the occupant based on the at least one evacuation route template and the corresponding passable status; and
communicating the evacuation route for use by the occupant.

10. The method of claim 9, wherein the generating step includes ensuring that the evacuation route conforms to a set of fire codes.

11. The method of claim 1, further comprising receiving an indication that an evacuation has been initiated for the structure.

12. The method of claim 1, further comprising obtaining location information for a second occupant in a communication received from the personal wireless communication device.

13. A system for managing an occupant of a structure during an emergency event, the system comprising:
an emergency response management system;
means for establishing communications between the emergency response management system and a personal wireless communication device of the occupant;
means for obtaining location information for the occupant on the emergency response management system, wherein the location information is based on at least one of an occupant profile, contact information used in establishing communications, or a communication received from the personal wireless communication device via at least one of an Internet message, a text message, a selection of at least one menu option, or a verbal statement; and
means for providing the location information from the emergency response management system for use by a responder.

14. The system of claim 13, further comprising:
means for registering the occupant with the emergency response management system; and
means for generating an occupant profile for the occupant based on the registration, wherein the occupant profile includes contact information for the occupant.

15. The system of claim 14, further comprising means for contacting the personal wireless communication device with at least one of an Internet message, a telephone call and a text message based on the contact information.

16. The system of claim 14, further comprising means for providing the contact information for use by a personal wireless communication device for the responder.

17. The system of claim 13, further comprising means for managing a plurality of evacuation route templates on the emergency response management system.

18. The system of claim 17, further comprising:
means for determining at least one evacuation route template for the occupant;
means for generating an evacuation route for the occupant based on the at least one evacuation route template and the corresponding passable status; and
means for communicating the evacuation route for use by the occupant.

19. The system of claim 13, further comprising:
means for obtaining evacuation status information for the occupant on the emergency response management system; and
means for providing the evacuation status information for use by the responder.

20. The system of claim 13, further comprising means for providing contact information for a plurality of locations for storage on the personal wireless communication device.

21. A computer-readable medium comprising computer program code, which when executed, enables a computer infrastructure to manage an occupant of a structure during an emergency event, the computer program code comprising:
means for obtaining an emergency response management system for the structure prior to the emergency event;
means for establishing communications between the emergency response management system and a personal wireless communication device of the occupant;
means for obtaining location information for the occupant on the emergency response management system, wherein the location information is based on at least one of an occupant profile, contact information used in establishing communications, or a communication received from the personal wireless communication device via at least one of an Internet message, a text message, a selection of at least one menu option, or a verbal statement; and
means for providing the location information from the emergency response management system for use by a responder.

22. The computer-readable medium of claim 21, wherein the computer program code further comprises:
means for obtaining evacuation status information for the occupant on the emergency response management system; and
means for providing the evacuation status information for use by the responder.

23. The computer-readable medium of claim 21, wherein the computer program code further comprises:
means for managing a plurality of evacuation route templates on the emergency response management system;
means for determining at least one evacuation route template for the occupant;
means for generating an evacuation route for the occupant based on the at least one evacuation route template, the corresponding passable status, and a set of fire codes; and
means for communicating the evacuation route for use by the occupant.

24. The computer-readable medium of claim 21, wherein the computer program code further comprises:
means for registering the occupant with the emergency response management system;
means for generating an occupant profile for the occupant based on the registration, wherein the occupant profile includes contact information for the occupant; and
means for providing the contact information for use by a personal wireless communication device for the responder.
